(19) United States
(12) Patent Application Publication
(10) Pub. No.: US 2026/0239309 A1
(43) Pub. Date: Aug. 13, 2026

(54) PHYSICAL LAYER PROCEDURES FOR INDICATING UNUSED CONFIGURED GRANT PUSCH TRANSMISSION OCCASIONS

(71) Applicant: Telefonaktiebolaget LM Ericsson (publ), Stockholm (SE)

(72) Inventors: Jonas FRÖBERG OLSSON, Ljungsbro (SE); Bikramjit SINGH, Raasepori (FI); Sorour FALAHATI, Raasepori (FI); Robert KARLSSON, Sundbyberg (SE); Du Ho KANG, Sollentuna (SE)

(21) Appl. No.: 19/156,712

(22) PCT Filed: Feb. 15, 2024
(86) PCT No.: PCT/SE2024/050152

§ 371 Date: Aug. 14, 2025

Related U.S. Application Data
(60) Provisional application No. 63/446,615, filed on Feb. 17, 2023.

(51) Int. Cl. H04W 72/0446; H04W 72/21; H04W 72/231; H04W 72/563

(52) U.S. Cl. CPC H04W 72/0446; H04W 72/21; H04W 72/231; H04W 72/563

(57) ABSTRACT

A method by a UE in a wireless communication network includes receiving a configuration for providing, to a network node, an indicator of a subset of a set of transmission occasions that are configured for the UE for performing uplink transmission. The subset of transmission occasions corresponds to transmission occasions, within the set of transmission occasions, that will all be used, may be used, or will be unused, by the UE to perform uplink transmission. The method further includes identifying the subset of transmission occasions, determining a physical layer procedure for providing the indicator to the network node based on the identified subset of transmission occasions, and transmitting the indicator to the network node in accordance with the determined physical layer procedure.

### BACKGROUND

In 3GPP work on eXtended Reality (XR), several enhancements have been proposed to increase XR capacity of 5G-Advanced systems.

XR includes services provided by computer technologies and wearables that allow for human-machine interaction in real/virtual mixed environments. XR includes Virtual Reality (VR), Augmented Reality (AR), Mixed Reality (MR), Cloud Gaming, and related applications. As such, XR is usually considered a mixed enhanced mobile broadband (eMBB)/ultra-reliable low-latency communication (URLLC) service. As shown in Table 1, XR traffic is a mixture of heterogeneous uplink (UL)/downlink (DL) data flows, including video, audio, and control traffic.

TABLE 1
XR traffic characteristics and requirements identified by 3GPP

| | | Data rate | Packet (frame) | Packet Delay Budget |
|---|---|---|---|---|
| | | [Mbps] | rate [fps] | (PDB) [ms] |
| DL | AR/VR Video | 30 | 60 | 10 |
| | Cloud Gaming | 30 | 60 | 15 |
| UL | Pose/control | 0.2 | 250 | 10 |
| | Video (Scene) | 10 | 60 | 30 |

Table 1 indicates that XR traffic flows have different characteristics, e.g., in terms of packet rate in frame per second [fps] and bit rate in bit per second [bps], and different requirements in terms of application packet delay budget (PDB) [ms]. Among XR flows, DL video and UL scene traffic are periodic (with possible jitter particularly in DL) and have variable large-sized application packets.

### Configured Grant

In 3GPP networks, the ConfiguredGrantConfig information element (IE) is used to provide a configured grant (CG) configuration for uplink transmission without a dynamic grant according to two possible schemes. The actual uplink grant may either be configured via radio resource control (RRC) (type1) or provided via a physical downlink control channel (PDCCH) message addressed to a cell specific radio network temporary identity (CS-RNTI) (type2). Multiple configured grant configurations may be configured in one bandwidth part (BWP) of a serving cell.

For both Type 1 and Type 2 configured grant, a user equipment (UE) is provided time-frequency resources on which the UE is allowed to transmit a message on the physical uplink shared channel (PUSCH). The time-frequency resources on which the UE is allowed to transmit PUSCH are referred to herein as Transmission Occasions (TOs).

For a Type 1 configured grant, the time-frequency resources are indicated using timeDomainAllocation, frequencyDomainAllocation and periodicity parameters together with a time reference to the slot in which the TO is located indicated in a RRC message. The periodicity indicates recurrence of the TOs. The timeDomainAllocation parameter indicates the first symbol of the PUSCH and the duration of the PUSCH (in symbols) and the frequencyDomainAllocation parameter indicates the resource blocks (RBs) used by the PUSCH. For example, timeDomainAllocation may indicate a starting symbol and an ending symbol (e.g., startSymbol=0 and endSymbol=14, where the PUSCH starts in the first symbol of the slot and ends in the last symbol) and the time reference may indicate that first TO is in slot 4. If the periodicity is 5 slots, then TOs for the configured grant would be present in the slots 4, 9, 14, 19, 24, . . . , etc. Once the UE has been configured with a Type 1 configured grant, the UE may or may transmit a PUSCH on the TOs for the configured grant until UE receives a RRC message disabling the configured grant.

The Type 2 configured grant is more flexible than the Type 1 configured grant in which the UE is provided the periodicity of the configured grant by RRC. In a Type 2 configured grant, the timeDomainAllocation and frequencyDomainAllocation parameters are provided via PDCCH, which simultaneously activates the configured grant. The timeDomainAllocation parameter together when the activation downlink control information (DCI) on PDCCH is sent to UE gives the time reference for first TO. The Type 2 configured grant can be deactivated by a deactivation DCI on a PDCCH.

When a UE has a configured grant, there are scheduling restrictions that restrict when the UE can be scheduled by a PDCCH. FIG. 1 illustrates a timeline constraint between PDCCH with DCI format dynamically scheduling a PUSCH when an overlapping configured grant PUSCH is absent (top) or present (bottom).

There are also restrictions on the slot format indicator (SFI) index if the UE is configured with configured grant of Type 2 and the configured grant is activated.

Further, there are restrictions for full or partial cancellation of a configured PUSCH if the UE detects a DCI format indicating to the UE to receive channel state information reference signals (CSI-RS) or physical downlink shared channel (PDSCH) on the set of symbols including the configured grant PUSCH.

### SUMMARY

A method performed by a UE in a wireless communication network according to some embodiments includes receiving a configuration for providing, to a network node in the wireless communication network, an indicator of a subset of a set of transmission occasions that are configured for the UE for performing uplink transmission. The subset of transmission occasions corresponds to transmission occasions, within the set of transmission occasions, that will all be used, may be used, or will be unused, by the UE to perform uplink transmission. The method further includes identifying the subset of transmission occasions, determining a physical layer procedure for providing the indicator to the network node based on the identified subset of transmission occasions, and transmitting the indicator that indicates the identified subset of transmission occasions to the network node in accordance with the determined physical layer procedure.

The physical layer procedure may include determining a timing condition based on the identified subset of transmission occasions.

Determining the timing condition may include determining a timing condition for a dynamically scheduled PUSCH transmission based on the indicator.

The physical layer procedure may include determining a slot format indicator restriction based on the identified subset of transmission occasions. The slot format indicator may indicate that a set of symbols of a slot, that is indicated by the indicator as being unused by the UE for uplink transmission, is a downlink or flexible slot.

The physical layer procedure may include generating unused transmission occasion, UTO, uplink control information, UCI, UTO-UCI, multiplexing the UTO-UCI with other UCI to provide multiplexed UCI, and transmitting the multiplexed UCI to the network node. The multiplexed UCI may be transmitted to the network node using a physical uplink shared channel, PUSCH.

In some embodiments, a priority index of the UTO-UCI is the same as a priority index of a configured grant PUSCH transmission.

In some embodiments, each configured grant PUSCH transmitted in a transmission occasion in the set of transmission occasions includes UTO-UCI.

In some embodiments, UTO-UCI is jointly encoded with hybrid automatic repeat request, HARQ, information.

The indicator that indicates the identified subset of transmission occasions may be an unused transmission occasion, UTO, indicator, and the physical layer procedure may include receiving the UTO indicator from a higher layer of a protocol stack within the UE.

The physical layer procedure may include selecting the UTO indicator from a set of UTO indicators configured by the higher layer.

Transmitting the indicator may be performed in a physical uplink shared channel, PUSCH, transmission in a configured grant that corresponds to one of the transmission occasions in the set of transmission occasions.

The physical layer procedure may include determining a periodicity with which to transmit the indicator. The periodicity of transmission of the indicator may be different than a periodicity of the transmission occasions.

In some embodiments, the physical layer procedure includes determining a RRC parameter to use when transmitting the indicator. The RRC parameter may include a beta offset parameter. The beta offset parameter may include a betaOffsetUTO-UCI parameter.

The set of transmission occasions may include a set of periodically repeating transmission occasions, and wherein the subset of the set of transmission occasions comprises a periodically repeating subset of the set transmission occasions.

The subset of transmission occasions may be determined based on an expected need for a periodically repeating uplink transmission requirement by a service operated by the UE. The service operated by the UE may include an extended reality, XR, service, and the periodically repeating uplink transmission requirement may include a requirement to perform uplink transmission of XR frames at a predetermined frame rate.

The subset of transmission occasions may include transmission occasions in which the UE will not perform uplink transmission, and the method may further include refraining from performing uplink transmission during the subset of transmission occasions.

In some embodiments, the subset of transmission occasions may include transmission occasions in which the UE will perform uplink transmission, and the method may further include refraining from performing uplink transmission during the transmission occasions in the set of transmission occasions other than transmission occasions in the subset of transmission occasions.

The method may further include receiving, from the wireless communication network, a configured grant that configures the UE with the set of transmission occasions for performing uplink transmission.

The method may further include receiving a confirmation of the indicator from the wireless communication network.

Transmitting the indicator to the wireless communication network may include transmitting the indicator in a UCI message.

Transmitting the indicator that indicates the identified subset of transmission occasions may be performed in response to a command by a higher protocol layer, or a medium access control protocol layer.

A UE according to some embodiments is adapted to receive a configuration for providing, to a network node in a wireless communication network, an indicator of a subset of a set of transmission occasions that are configured for the UE for performing uplink transmission. The subset of transmission occasions corresponds to transmission occasions, within the set of transmission occasions, that will all be used, may be used, or will be unused, by the UE to perform uplink transmission. The UE is further adapted to identify the subset of transmission occasions, determine a physical layer procedure for providing the indicator to the network node based on the identified subset of transmission occasions, and

transmit the indicator that indicates the identified subset of transmission occasions to the network node in accordance with the determined physical layer procedure.

A method performed by a network node of a wireless communication network according to some embodiments includes configuring a UE with a configured grant that configures the UE with a set of transmission occasions for performing uplink transmission, and receiving an indicator from the UE indicating a subset of the set of transmission occasions that are configured for the UE for performing uplink transmission. The subset of transmission occasions corresponds to transmission occasions, within the set of transmission occasions, that will all be used, may be used, or will be unused, by the UE to perform uplink transmission. The method further includes scheduling future transmissions and/or receptions in the set of transmission occasions based on the indicator.

The method may further include transmitting an acknowledgement message to the UE acknowledging the indicator in response to receiving the indicator.

The indicator may indicate that the subset of the set of transmission occasions will not be used by the UE for performing uplink transmission, and the method may further include re-allocating a transmission occasion in the subset of the set of transmission occasions to another UE.

In some embodiments, the indicator indicates that only the subset of the set of transmission occasions will be used by the UE for performing uplink transmission, and the method further includes re-allocating transmission occasions in the set of transmission occasions, other than those transmission occasions in the subset of the set of transmission occasions, to another UE.

The method may further include configuring the UE to provide the indicator indicating the subset of transmission occasions, within the set of transmission occasions, that will all be used, may be used, or will be unused, by the UE to perform uplink transmission.

Some embodiments provide a network node of a wireless communication network adapted to configure a user equipment, UE, with a configured grant that configures the UE with a set of transmission occasions for performing uplink transmission, to receive an indicator from the UE indicating a subset of the set of transmission occasions that are configured for the UE for performing uplink transmission, wherein the subset of transmission occasions corresponds to transmission occasions, within the set of transmission occasions, that will all be used, may be used, or will be unused, by the UE to perform uplink transmission, and to schedule future transmissions and/or receptions in the set of transmission occasions based on the indicator.

### BRIEF DESCRIPTION OF THE DRAWINGS

FIG. 1 illustrates a timeline constraint between PDCCH with DCI format dynamically scheduling a PUSCH when an overlapping configured grant PUSCH is absent or present.

FIG. 2 illustrates serving XR traffic using CG on a time division duplex carrier with a DDDUU pattern on 30 kHz sub-carrier spacing.

FIG. 3 illustrates a timeline relationship for the DCI scheduling a PUSCH, in the absence or presence of overlapping configured PUSCH.

FIG. 4 illustrates new functionality for indicating unused TOs.

FIG. 5 illustrates operations of a UE according to some embodiments.

FIG. 6 illustrates operations of a network node according to some embodiments.

FIG. 7 shows an example of a communication system in accordance with some embodiments.

FIG. 8 shows a UE in accordance with some embodiments.

FIG. 9 shows a network node in accordance with some embodiments.

FIG. 10 is a block diagram of a host in accordance with some embodiments.

FIG. 11 is a block diagram illustrating a virtualization environment in which functions implemented by some embodiments may be virtualized.

FIG. 12 shows a communication diagram of a host communicating via a network node with a UE over a partially wireless connection in accordance with some embodiments.

### DETAILED DESCRIPTION OF EMBODIMENTS

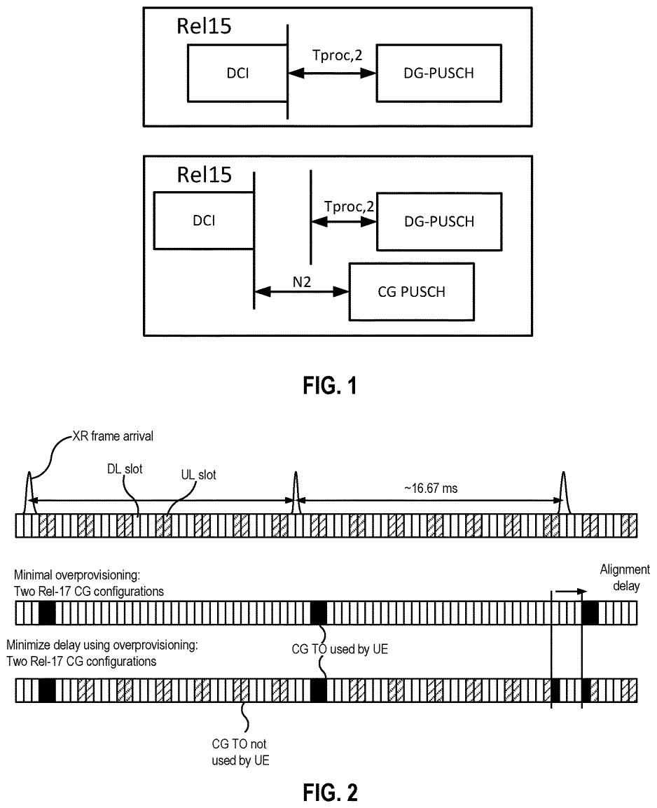

A problem with using configured grants is that XR frame rates have a non-integer periodicity, e.g. 60 frames/second≈16.67 ms. In contrast, in a 3GPP Long Term Evolution (LTE) or New Radio (NR) system, DL and UL transmissions are organized into radio frames of 10 ms each. Each frame is divided into ten equally sized subframes. The duration of each subframe is 1 ms. Moreover, each subframe is further divided into two equally sized time slots, that is, each time slot is 0.5 ms. This means that XR frame transmissions cannot maintain timing alignment with the timing of time slots used for configured grants. This makes it impossible to perfectly align CG TOs with the arrival of XR frames to be transmitted by the UE. This becomes especially difficult on time division duplex (TDD) carriers. When utilizing CG to serve XR traffic the base station (i.e., a gNodeB or gNB) often needs to make a tradeoff between latency and overprovisioning, as illustrated in FIG. 2. In particular, FIG. 2 illustrates serving XR traffic using CG on a TDD carrier with a DDDUU pattern of three downlink slots followed by two uplink slots with 30 kHz sub-carrier spacing (SCS).

During the XR study item for 3GPP Release 18 (or Rel-18) a concern has been raised that 3GPP Release 17 (or Rel-17) CG leads to severe over provisioning when CG is used to serve XR traffic. Although XR traffic in the uplink is expected to be periodic, the XR frame size is randomly distributed, which makes use of CG to serve XR traffic difficult. Another problem is that the XR periodicity is not aligned with the CG periodicities that can be configured.

In the XR Work Item Description (WID) for Rel-18, it has been agreed to include an objective to solve the over provisioning problem and improve XR capacity when CG is used to serve XR traffic by enabling the UE to dynamically indicate unused CG PUSCH occasion(s) based on UCI. In particular, the WID intends to specify the enhancements related to capacity through dynamic indication of unused CG PUSCH occasion(s) based on UCI by the UE.

Some embodiments provide systems/methods that identify a set of sub-sets of the plurality of TOs that have been allocated in a CG. The systems/methods select a sub-set of TOs. The selected subset of TOs is a set of TOs to be unused (or to be used) by the UE for uplink transmission.

The UE transmits an indicator to the network indicating the selected sub-set of TOs. To do so, the UE may construct a UCI message containing the indicator, and multiplex the constructed UCI with other UCI.

Based on the subset of TOs indicated to the network, the UE may determine/modify physical layer procedures based on transmitted indicator. Such physical (PHY) layer procedures may include timing conditions and restrictions on slot format indications. Additionally, the UE may refrain from transmitting PUSCH in a TO that is indicated as “unused” by the indicator. As known in the art, the physical, or PHY, layer is a logical layer of a protocol stack in the UE along with higher layers such as medium access control (MAC), radio resource control (RRC) and others.

Some embodiments provide physical layer procedures for obtaining an unused TO (UTO) indicator (where the UTO indicator indicates one or more unused TOs out of a plurality of TOs) and transmitting the UTO indicator to the network. To do so, the PHY layer may construct UCI (UTO-UCI) for the UTO indicator, multiplex UTO-UCI with other UCI, and transmit a PUSCH containing the UTO-UCI.

Some embodiments may reduce resource utilization due to transmission based on configured grant when overprovisioned CG is used to serve XR traffic.

Some of the embodiments contemplated herein will now be described more fully with reference to the accompanying drawings. Embodiments are described by way of example to convey the scope of the subject matter to those skilled in the art.

In the below embodiments, functionality is described for indicating ‘unused’ TOs using RRC, PHY, and other higher layer configurations. However, the same embodiments can be utilized to indicate ‘used’ TOs, instead of unused TOs. For instance, if a UCI indicating subset of unused TOs, the concept in the embodiments can be used to reinterpret or repurpose the functionality to indicate ‘used’ TOs from the group/plurality of TOs, because:
‘used TOs set’=‘plurality/group of TOs set’ MINUS ‘unused TOs set’

Some embodiments provide indications about the TOs as being “used” or “unused.” However, this does not exclude the possibility of other states. For example, there may be three states “used”, “unused” and “may be used” where “may be used” indicates that the UE has not yet decided if the UE needs to use the TO or not. The UE behavior for “may be used” can, for example, be that the UE will use the TO if the UE has data to transmit and the UE does not use the TO if the UE do not have data to transmit (like how skip uplink works). The UE may be configured with which of the states (e.g., “used”, “unused”, or “may be used”) the UE is allowed to select, or which states the UE must select (e.g., the UE may not select “may be used” and must select which TOs the UE will not use).

In some embodiments, “configured uplink grant transmission”, “CG TOs”, “PUSCH duration of configured grant”, “configured grant PUSCH”, “PUSCH is correspond to a configured grant” etc., are various ways to express reference a transmission occasion where UE may transmit a PUSCH associated/assigned by a configured grant. Furthermore, in the 3GPP medium access control (MAC) specification, a configured grant is considered to “reoccur” or “sequentially occur” as shown in Clause 5.8.2, of 3GPP TS 38.321, reproduced in Table 2 below:

TABLE 2
Clause 5.8.2, of 3GPP TS 38.321

Upon configuration of a configured grant Type 1 for a BWP of a Serving Cell by upper layers,
the MAC entity shall:

| | |
|---|---|
| 1> | store the uplink grant provided by upper layers as a configured uplink grant for the |
| | indicated BWP of the Serving Cell; |
| 1> | initialise or re-initialise the configured uplink grant to start in the symbol according to |
| | timeDomainOffset, timeReferenceSFN, and S (derived from SLIV or provided by |
| | startSymbol as specified in TS 38.214 [7]), and to reoccur with periodicity. |

After an uplink grant is configured for a configured grant Type 1, the MAC entity shall
consider sequentially that the N^{th} (N >= 0) uplink grant occurs in the symbol for which:

```
      [(SFN × numberOfSlotsPerFrame × numberOfSymbolsPerSlot)
+ (slot number in the frame × numberOfSymbolsPerSlot) + symbol number in the slot] =
  (timeReferenceSFN × numberOfSlotsPerFrame × numberOfSymbolsPerSlot
    + timeDomainOffset × numberOfSymbolsPerSlot + S + N × periodicity)
    modulo (1024 × numberOfSlotsPerFrame × numberOfSymbolsPerSlot)
```

The reoccurring and sequentially occurring is sometimes viewed as that there are multiple TOs associated with a configured grant and sometimes viewed as that a reoccurring or sequentially occurring uplink (configured) grant.

In some embodiments, the UTO indicator may indicate one or more TOs out of a set of TOs referenced/identified (by e.g. a bitmap) as ‘unused’ wherein the TOs out of the set of referenced/identified TOs not indicated as ‘unused’ may be considered as ‘used’ or ‘may be used”.

In some embodiments, the UE determines timing conditions for dynamically scheduled PUSCH transmissions based on an indicator for unused TOs. The UE may determine a PUSCH as not allowed if the PUSCH is a PUSCH with a configured grant and the PUSCH is associated with a TO which the transmitted unused TO indicator has indicated as “unused”. For example, there may be defined conditions a potential PUSCH transmission with a configured grant is allowed, such as “if UE is configured with <unusedTosIndicator> and UE has transmitted “unusedTosIndicator” indicating a transmission occasion for a PUSCH with configured grant as unused, the UE shall not transmit the PUSCH transmission with configured grant.”

The phrase “UE configured with <unusedTosIndicator>” means a RRC configuration that the UE shall perform provide an indication as described herein and “unusedTosIndicator” is indicator of unused TOs.

An alternative formulation may be: “If UE is configured with <unusedTosIndicator> and UE has transmitted “unusedTosIndicator” indicating a PUSCH with configured grant as unused, the UE does not transmit the PUSCH.”

A further other formulation may be: “If UE is configured with <unusedTosIndicator>, the UE does not transmit a PUSCH with configured grant indicated by “unusedTosIndicator” as unused.”

In some embodiments, the UE expects a SFI index to indicate a set of symbols of the slot as “downlink” or “flexible,” and the symbols of the slot include symbols corresponding to any repetition of a PUSCH transmission activated by a Type 2 configured grant if the UE indicated using <unusedTosIndicator> that the PUSCH transmission is an unused PUSCH transmission. For example, Clause 11.1.1 of 3GPP TS 38.213 may be amended to include the highlighted addition shown in Table 3 below.

TABLE 3
Proposed Modification to Clause 11.1.1 of 3GPP TS 38.213

| | |
|---|---|
| - | a UE does not expect to detect an SFI-index field value in DCI format 2_0 indicating the |
| | set of symbols of the slot as downlink or flexible if the set of symbols of the slot |
| | includes symbols corresponding to any repetition of a PUSCH transmission activated, |
| | but not indicated as unused by <unusedTosIndicator>, by an UL Type 2 grant |
| | PDCCH as described in clause 10.2 |

In some embodiments, if a UE indicates a configured grant PUSCH transmission as an unused PUSCH, the timeline constraint for dynamically scheduling a PUSCH overlapping with the configured PUSCH resource in the current specification is not applicable. That implies the last symbol of PDCCH carrying a DCI format scheduling a PUSCH that overlaps with a configured grant PUSCH that is indicated as unused, is not required to be at least N2 symbols earlier than the first symbol of configured PUSCH. It is sufficient that the minimum required PUSCH processing time (i.e. Tproc,2) is respected between the PDCCH and scheduled PUSCH.

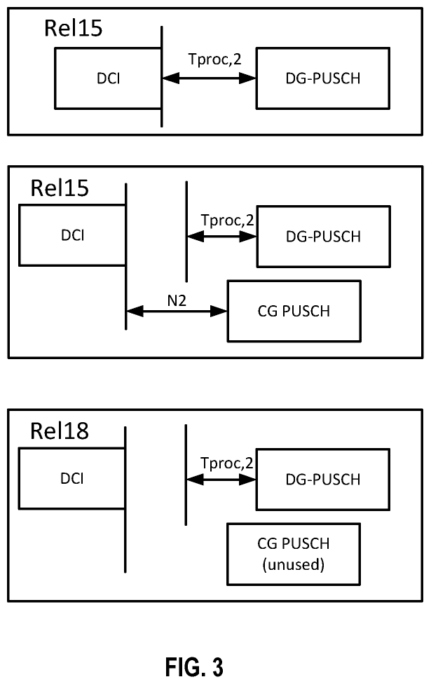

FIG. 3 illustrates a timeline relationship for the DCI scheduling a PUSCH, in the absence or presence of overlapping configured PUSCH. If the overlapping configured grant PUSCH is indicated as unused, the behavior would be a configured PUSCH is absent.

In some embodiments, the timeline restriction for full or partial cancellation of a configured PUSCH described in Clause 11.1 and 11.1.1. of 3GPP TS 38.213 when the UE detects a DCI format indicating to the UE to receive CSI-RS or PDSCH on the set of symbols including the configured grant PUSCH, is not applicable if the configured grant PUSCH is indicated as “unused”.

In some embodiments, to distinguish between configured grant PUSCH resources that can be used for transmission and configured grant PUSCH resources that are indicated by the UE to not to be used for transmission, the specification can apply a description to make this distinction. Therefore, the related procedures would be applicable only to the configured PUSCH transmissions that can be used for transmission. The description below is an example for this purpose, that can be used in specifications such as, Clause 9 or 11.1 of 3GPP TS 38.213 or Clause 6.1 of 3GPP TS 38.214 when applicable: “If UE is configured with <unusedTosIndicator> and a PUSCH with configured grant is indicated by “unusedTosIndicator” as unused, the UE assumes that the PUSCH is not configured by higher layers.”

In some embodiments, the PHY layer in the UE obtains a UTO indicator from higher layer (e.g. MAC, RRC) or from a processing unit. In other embodiments, the PHY layer in the UE determines the UTO indicator from a selection among higher layer configured set of UTO indicators. In some such embodiments, PHY layer procedures in the UE determine if a transport block (TB) delivered by the MAC layer is to be transmitted on a TO that UE indicated as unused TO. If the TB delivered by the MAC layer is for an unused TO, then the PHY layer refrains from transmitting a PUSCH comprising the TB on the unused TO. In a further example, the PHY layer in the UE may determine the UTO indicator, perform the transmission and rely on that the MAC layer does not deliver a TB to the PHY layer for TOs indicated as unused. In such examples, the MAC layer may be indicated by the PHY layer, or the MAC layer may be just aware of the UTO indicator determined by the PHY layer.

In some embodiments, the UE is configured with a single sub-set of TOs and the PHY layer implicitly transmits the UTO indicator. When the PHY layer implicitly transmits the UTO indicator no bits for the indicator are included in UCI, but the PHY layer refrains from transmitting a PUSCH on TOs indicated as unused by the indicator.

In some embodiments, the UE transmits a UTO indicator in every PUSCH transmitted with a configured grant. In other embodiments, the UE transmits a UTO indicator at pre-determined occasions or configured occasions. For example, the UE may transmit a UTO indicator in every second, third, etc., occasion where UE can send PUSCH with the configured grant. In another example, the UE may transmit a UTO indicator in every second, third, etc, PUSCH transmitted with configured grant. In further embodiments, the UE may transmit a UTO indicator in any PUSCH transmitted with the configured grant. In some embodiments, the UE may transmit a first UTO indicator with a first PUSCH with configured grant and may transmit a second UTO indictor with a second PUSCH with configured, where the first and second PUSCH are different PUSCHs, but TOs indicated as ‘unused’ by the first indicator and referenced by the second indicator are also indicated as ‘unused’ by the second indicator. For example, the first indicator may be transmitted in slot 4 and reference TOs in slots {9, 14, 19} and indicate TOs in slots {14, 19} as ‘unused’ while the second indicator may be transmitted in slot 9 and reference TOs in slots {14, 19, 24} and indicate slots {19, 24} as ‘unused’.

The predetermined or configured TOs may be every TO, every second TO, etc., of the configured grant.

In some embodiments, the UTO indicator may indicate one or more TOs out of a set of TOs referenced/identified (e.g., by a bitmap) as ‘unused’ wherein the TOs out of the set of referenced/identified TOs not indicated as ‘unused’ may be considered as ‘used’ or ‘may be used”.

In some embodiments, every CG PUSCH is configured to include a UTO indicator as UTO-UCI and if a UE transmits such PUSCH, the PUSCH includes UTO-UCI as UCI. Hence, the gNB always can decode such PUSCH assuming UTO-UCI is always present. In other words, if a UE transmits a TB including data and/or other control information in a PUSCH, the UE must include UTO-UCI in the PUSCH as well. If there is no data to transmit on the PUSCH, then the UE does not transmit over the PUSCH (and nor the UTO-UCI).

In other embodiments, the UE may only be allowed to transmit a UTO indicator (UTO-UCI) at pre-determined PUSCHs/occasions or configured occasions.

For example, a UE may transmit a UTO indicator in every second, third, etc. occasion where UE can send PUSCH with the configured grant. In another example, the UE may transmit a UTO indicator in every second, third, etc., PUSCH transmitted with the configured grant.

In another example, the UTO-UCI occasions can be configured with some periodicity which can be the same or different from the CG periodicity, and the UE can transmit TB and UTO-UCI in CG PUSCH only in those CG occasions that overlap with the UTO-UCI occasions. Hence, the gNB will expect a UTO-UCI and a TB in such occasions (not just TB only) multiplexed in the PUSCH. As in the previous embodiment, if there is no TB to transmit, the UE will not transmit UTO-UCI on such CG occasions.

In another embodiment, the PUSCHs are configured to include UTO-UCI, but some rules are applied for where UE includes UTO-UCI in the specific transmission(s). One example is that the UE will always include UTO-UCI in the first transmission, but not in remaining transmissions in a CG period with multiple PUSCHs. Elaborating the example, assume there is a CG for multi-PUSCH with 6 PUSCHs per period (within the CG periodicity). Assume further that the UE transmits its first transmission in 3rd PUSCH (and remaining transmissions on 4th and 5th PUSCH). Then, the UE must include UTO-UCI only in 3rd PUSCH but not in 4th and 5th PUSCH.

In further embodiments, the UE is configured to transmit a TB with or without UTO-UCI multiplexed on the PUSCH, the UE can decide whether to transmit UTO-UCI or not. This has the highest cost in terms of blind decode at gNB side, as gNB may require to decode same PUSCH with both options with PUSCH having TB and UTO-UCI, or only TB (without UTO-UCI).

In some embodiments, the UTO indicator may indicate that no TOs are unused. For example, a bitmap with all ‘0’ may indicate that no TOs are unused.

In some embodiments, when bits for the UTO indicator are always included in CG PUSCH, one value for UTO indicator may be reserved to indicate that the bits for UTO indicator do not carry any information of unused TOs. For example, the first or last index of an RRC configured table could be reserved for indicating “no UTO information present”. In further other embodiments, bits for the UTO indicator may always included in CG PUSCH if the size of the set of subsets of plurality of TOs configured is lower than a threshold.

In further other embodiments, a UE may be configured with a configuration <always include UTO bits> to require the UE to always include bits for UTO indicator in CG PUSCH. If the UE is not configured with <always include UTO bits>, then a bit for UTO indicator is present if the UTO indicator is transmitted.

### UTO Indicator Included as a Field in CG-UCI

In some embodiments, the UE transmits the UTO indicator included as a field in CG-UCI, i.e., CG-UCI may be transmitted even though cg-RetransmissionTimer is not configured. Table 4 illustrates a proposed mapping order of CG-UCI fields according to some embodiments.

TABLE 4
Proposed Mapping Order of CG-UCI Fields

| Field | Bitwidth |
|---|---|
| HARQ process number | 0 if cg-RetransmissionTimer is not configured; |
| | 5 if nrofHARQ-Processes-v1700 in ConfiguredGrantConfig is |
| | configured; |
| | 4 otherwise. |
| Redundancy version | 2 if cg-RetransmissionTimer is configured; |
| | 0 otherwise |
| New data indicator | 1 if cg-RetransmissionTimer is configured; |
| | 0 otherwise |
| Channel Occupancy Time | 0 if cg-RetransmissionTimer is not configured; |
| (COT) sharing information | ┌log₂C┐ if both higher layer parameter ul-toDL-COT-SharingED- |
| | Threshold and higher layer parameter cg-COT-SharingList are |
| | configured, or if both higher layer parameter |
| | semiStaticChannelAccessConfigUE and higher layer |
| | parameter cg-COT-SharingList are configured, or if higher |
| | layer parameter cg-COT-SharingList is configured in frequency |
| | range 2-2, where C is the number of combinations configured |
| | in cg-COT-SharingList; |
| | 1 if higher layer parameter ul-toDL-COT-SharingED-Threshold |
| | is not configured, and if higher layer parameter |
| | semiStaticChannelAccessConfigUE is not configured, and if |
| | higher layer parameter cg-COT-SharingOffset is configured; |
| | 0 otherwise. |
| | If a UE indicates COT sharing other than “no sharing” in a CG |
| | PUSCH within the UE's initiated COT, the UE should provide |
| | consistent COT sharing information in all the subsequent CG |
| | PUSCHs, if any, occurring within the same UE's initiated COT |
| | such that the same DL starting point and duration are |
| | maintained. |
| Unused TOs indicator | X if <unusedTosIndicator> configured; |
| Or | 0 otherwise |
| Unused TOs pattern | |

In some embodiments, the UE cannot be configured with both cg-Retransmission Timer and <unusedTosIndicator>.

TABLE 5
Proposed Modification to Clause 6.2.3.2.1.4 of 3GPP TS 38.212

```
6.3.2.1.4 CG-UCI or UTO-UCI and HARQ-ACK
When higher layer parameter cg-UCI-Multiplexing or uto-UCI-Multiplexing is configured, the
UCI bit sequence a₀, a₁, a₂, a₃, . . . , a_{A-1} is determined as follows, where A = O^{CG-UCI} + O^{ACK}.
    The CG-UCI or UTO-UCI bits are mapped to the UCI bit
    $sequence {a}_{0} , {a}_{1} , {a}_{2} , {a}_{3} , … , {a}_{{O}^{C G - UCI} - 1} , where {a}_{i} = {\tilde{o}}_{i}^{C G - UCI} for i = 0 , 1 , … , {O}^{C G - UCI} - 1 .$
    $The CG - UCI or UTO - UCI bit sequence {\tilde{o}}_{0}^{CG - UCI} , {\tilde{o}}_{1}^{CG - UCI} , … , {\tilde{o}}_{{O}^{CG - UCI} - 1}^{CG - UCI} is given by$
    Table 6.3.2.1.3-1 mapped in the order from upper part to lower part, and O^{CG-UCI} is
    number of CG-UCI bits or UTO-UCI bits;
    The HARQ-ACK bits are mapped to the UCI bit sequence a_{O}_{^{CG-UCI}}, a_{O}_{^{CG-UCI}}_{₊₁},
    $… , {a}_{{O}^{C G - UCI} + {O}^{ACK} - 1} , where {a}_{i + {O}^{C G - UCI}} = {\tilde{o}}_{i}^{A C K} for i = 0 , 1 , … , {O}^{A C K} - 1. The HARQ -$
    $ACK bit sequence {\tilde{o}}_{0}^{ACK} , {\tilde{o}}_{1}^{ACK} , … , {\tilde{o}}_{{O}^{A C K} - 1}^{A C K} is given by Clause 9.1 of [ 5 , TS 38.213 ] , and$
    O^{ACK} is number of HARQ-ACK bits.
```

In some embodiments, CG-UCI includes X bits for the UTO indicator if UE is configured with <unusedTosIndicator>. The value of X may be a fixed value or depend on the number of different indicators UE may send. For example, the gNB may configure the UE with M subsets of the plurality of TOs, then UE may determine X=┌log 2(M)┐ where ┌.┐ denotes the “ceiling” operation. In some examples of this embodiment, when the UE does not transmit UTO indicator in every CG PUSCH transmitted by the UE, the UE includes X bits for UTO indicator if transmitted by UE and zero bits otherwise. In other such examples, the always includes X bit although the UTO indicator is not sent. In some other example, the bit field for the UTO indicator may be undefined (i.e., would have no meaning), or it would be enforced by specification a certain bit combination. For example, if no UTO indicator is sent, the UE shall set the UTO indicator field as all ‘1’ or all ‘0’. In some examples, the UE may always include X bits in CG-UCI if cg-RetransmissionTimer is configured.

In some embodiments, the UE includes X bits in CG-UCI if <unusedTosIndicator> is configured and the UE transmits a UTO indicator, otherwise UE includes X=0 bits. In some embodiments, when cg-RetransmissionTimer is not configured, the UE does not include CG-UCI in CG PUSCH if transmission if the UTO indicator is not triggered.

In some embodiments, if cg-RetransmissionTimer is not configured but <unusedTosIndicator> is configured, the UE may be configured with one or more of the Rel-17 RRC parameters betaOffsetCG-UCI and cg-UCI-Multiplexing to be used in physical layer procedures. That is, Rel-17 RRC parameters and physical layer procedures may be re-used although CG-UCI does not include the fields for Rel-17 CG-UCI.

In some embodiments, the UE is configured with new RRC parameters betaOffsetCG-UCI, unusedTO to be used in physical layer procedures when X>0 while if X=0 then legacy betaOffsetCG-UCI is used in physical layer procedures. As known in the art, the beta offset is a coding offset for UTO-UCI relative to coding of data.

In one embodiment, the UTO indicator/pattern bitfield in above table indicates options. The bitfield contains a value which points to a row of some RRC table indicating the pattern of unused TOs.

In some embodiments, the bitfield contains a value indicating directly which TOs should be unused. In one example, when a bitfield indicates a pattern of 10001, then it can mean that out of 5 TOs, the first and the last TOs are unused, or otherwise that the 2nd, 3rd, 4th TOs are unused, depending how the network defines bit ‘1’ and bit ‘0’.

UTO Indicator Included as a Field in CG-UCI with a Restriction

In some embodiments, the CG-UCI fields can be configurable to indicate either legacy CG-UCI functionality (to indicate NR-U CG's autonomous PUSCH parameters), or to indicate unused TOs (UTOs), i.e., UTO-UCI.

Table 6 illustrates mapping order of CG-UCI fields including restriction.

TABLE 6
Proposed Mapping order of CG-UCI fields

| Field | Bitwidth |
|---|---|
| HARQ process number | {5 if nrofHARQ-Processes-v1700 in ConfiguredGrantConfig is |
| | configured; |
| | 4 otherwise} if cg-RetransmissionTimer is configured and |
| | <unusedTosIndicator> not configured |
| Redundancy version | 2 if cg-RetransmissionTimer is configured and |
| | <unusedTosIndicator> not configured |
| New data indicator | 1 if cg-RetransmissionTimer is configured and |
| | <unusedTosIndicator> not configured |
| Channel Occupancy Time | { |
| (COT) sharing information | ┌log₂C┐ if both higher layer parameter ul-toDL-COT-SharingED- |
| | Threshold and higher layer parameter cg-COT-SharingList are |
| | configured, or if both higher layer parameter |
| | semiStaticChannelAccessConfigUE and higher layer |
| | parameter cg-COT-SharingList are configured, or if higher |
| | layer parameter cg-COT-SharingList is configured in frequency |
| | range 2-2, where C is the number of combinations configured |
| | in cg-COT-SharingList; |
| | 1 if higher layer parameter ul-toDL-COT-SharingED-Threshold |
| | is not configured, and if higher layer parameter |
| | semiStaticChannelAccessConfigUE is not configured, and if |
| | higher layer parameter cg-COT-SharingOffset is configured; |
| | 0 otherwise. |
| | If a UE indicates COT sharing other than “no sharing” in a CG |
| | PUSCH within the UE's initiated COT, the UE should provide |
| | consistent COT sharing information in all the subsequent CG |
| | PUSCHs, if any, occurring within the same UE's initiated COT |
| | such that the same DL starting point and duration are |
| | maintained. |
| | } |
| | if cg-RetransmissionTimer is configured and |
| | <unusedTosIndicator> not configured |
| Unused TOs indicator | X if <unusedTosIndicator> configured and cg- |
| Or | Retransmission Timer is not configured |
| Unused TOs pattern | |

Table 7 illustrates how and when two of above functionalities can be used/indicated.

TABLE 7
UCI will be repurposed to indicate legacy CG-UCI functionality
and new functionality based on reporting unused TOs.

| | Parameter | | | |
|---|---|---|---|---|
| Feature type | dependence | Applicability | Flexibility | Restriction |
| Legacy CG- | ’cg- | NR-U CG | CGRT is must if NR-U | Both CGRT (legacy |
| UCI | RetransmissionTimer’ | based on | CG based on Release | CG-UCI |
| functionality | (CGRT) | Released | 16 is utilized, because | functioanlity) and |
| | configured | 16 (which | this defines the | ReportingUnusedTOs |
| | | can be | autonomous behavior | (UTO-UCI) cannot be |
| | | used in 17 | of PUSCHs | configured or enable |
| | | and | | at the same time |
| | | onwards) | | |
| To indicate | Define new | NR CG | This parameter can be | |
| unused TOs, | parameters/capability, | NR-U CG | set optional: It means | |
| or UTO- | e.g., | based on | if n/w | |
| UCI | <unusedTosIndicator> | NR CG in | enables/activates NR | |
| functioanlity | configured | Release | CG or NR-U CG (based | |
| | | 17 (which | on NR GC Rlease 17), | |
| | | is enabled | it is not a hard | |
| | | for use in | requirement to enable | |
| | | NR-U as | this parameter | |
| | | well) | (ReportingUnusedTOs) | |
| | | | unless n/w wants to | |
| | | | enable functioanility | |
| | | | to contain wastage | |
| | | | provided UE has the | |
| | | | capability or possiblity | |
| | | | to report such | |
| | | | indication | |

The network can utilize legacy CG-UCI fields to indicate legacy CG-UCI functionality or reporting unused indication (UTO-UCI) by repurposing the fields depending on the applicable scenario and the UE's capability, as shown Table 8.

TABLE 8
Alternative version of Table 7

| | | | Rel-X NR-U | |
|---|---|---|---|---|
| | | | Rel-X NR-U CG | |
| CG-UCI | | | based on ’NR-U | Rel-X NR-U CG |
| (legacy CG- | | | CG Release | based on ’NR CG |
| UCI | | | 16’/configured | Release 17’/’no |
| functionailty) | UTO-UCI | NR | CGRT | CGRT configured’ |
| Not | Not | Allowed | Not allowed | Allowed |
| configured | configured | | | |
| Not | Configured | Allowed | Not allowed | Allowed |
| configured | | | | |
| Configured | Configured | Errrroneous configuration as both legacy CG-UCI | | |
| | | functionality and unused TOs indication cannot be | | |
| | | enabled/configured at the same time | | |
| Configured | Not | Not | Allowed | Not allowed |
| | configured | allowed | | |

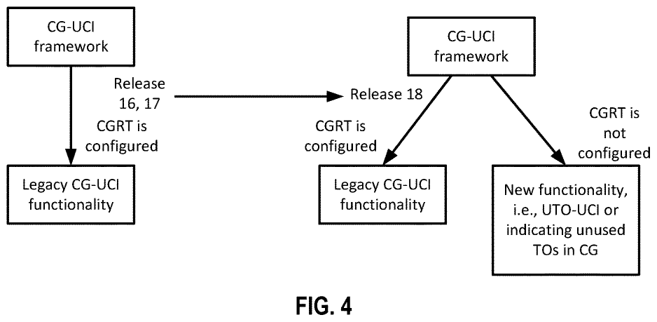

In other words, based on this embodiment, the network intends to utilize CG-UCI framework to indicate legacy-UCI functionality (for which ‘cg-RetransmissionTimer’ is a must for NR-U) or to indicate new functionality to indicate unused TOs/PUSCHs (UTO-UCI) in both NR and NR-U, which is illustrated in FIG. 4.

With this behavior, the same CG-UCI framework can be used, e.g., multiplexing procedure, beta offsets, etc., irrespective what is indicated inside (legacy CG-UCI functionality or UTO-UCI). For instance, in Clause 6.3.2.1.4 (HARQ-ACK and CG-UCI) of 3GP TS 38.212, the CG-UCI parameters, such as cg-UCI-Multiplexing may be configured in the same manner irrespective what is indicated by CG-UCI (either from 2 functionalities). In other words, the same CG-UCI and HARQ-ACK multiplexing procedure would apply if CG-UCI happens to indicate unused TOs/UTO-UCI.

### UTO Indicator Included as New UCI

In some embodiments, the UE transmits a UTO indicator as new UCI, here referenced as UTO UCI or UTO-UCI. Hence, in embodiments CG-UCI is present as UCI if cg-RetransmissionTimer is configured and not present otherwise.

In some embodiments, a table for determining the UTO indicator is used as shown in Table 9.

TABLE 9
Unused indicator UCI (UTO-UCI) when <unusedTosIndicator>
configured.

| Field | Bitwidth |
|---|---|
| Unused TOs indicator | X bits <bit size description> |
| Or | |
| Unused TOs pattern | |

In Table 9, <bit size description> is a description the value of X which may be a fixed value or may depend on the number of different indicators UE may send. For example, the gNB may configure the UE with M subsets of the plurality of TOs, then UE may determine X=┌log 2(M)┐ where ┌.┐ denotes the “ceiling” operation. In some examples, when the UE does not transmit a UTO indicator in every CG PUSCH transmitted by UE, the UE includes X bits for the UTO indicator if transmitted by the UE, and zero bits otherwise. In other examples, the UE always includes X bits although the unused TOs indicator is not sent. In some other examples, the bit field for the UTO indicator may be undefined (i.e., would have no meaning), or it ay be enforced by specification a certain bit combination. For example, if no UTO indicator is sent, the UE shall set the unused TOs indicator field as all ‘1’ or all ‘0’.

In some embodiments, the UE is not allowed to be configured with both cg-RetransmissionTimer and <unusedTosIndicator>. In some embodiments, the Rel-17 physical layer procedures and RRC parameters for CG-UCI are re-used when <unusedTosIndicator> is configured. For example, betaOffsetCG-UCI is configured if cg-RetransmissionTimer is configured or if <unusedTosIndicator> is configured. Another example is the procedures in 3GPP TS 38.212 which could state that if <unusedTosIndicator> is configured, then “CG-UCI” shall be read as “UTO-UCI”. In other embodiments, new RRC parameters (as shown in Table 10 below) are introduced specific to UTO-UCI, while the text for physical layer procedures is modified. For example, Clause 9.3 of 3GPP TS 38.213 may be modified as shown below in Table 10.

TABLE 10
Proposed Modification to Clause 9.3 of 3GPP TS 38.213

For a PUSCH transmission that is configured by a ConfiguredGrantConfig and
includes CG-UCI or UTO-UCI, the UE multiplexes CG-UCI or UTO-UCI in the
PUSCH transmission if the UE is provided by betaOffsetCG-UCI or betaOffsetUTO-
$UCI a {I}_{offset}^{CG - UCI} or {I}_{offset}^{UTO - UCI} value , from a set of values , with the mapping defined in$
Table 9.3-1. If the UE is provided cg-UCI-Multiplexing or uto-UCI-Multiplexing and
multiplexes HARQ-ACK information in the PUSCH transmission, as described in
clauses 9 and 9.2.5, the UE jointly encodes the HARQ-ACK information and the CG-
UCI or UTO-UCI [5, TS 38.212] and determines a number of resources for
$multiplexing the combined information in a PUSCH using {β}_{offset}^{H ARQ - ACK} which provides$
$indexes {I}_{offset , 1}^{HARQ - ACK} and {I}_{offset , 2}^{H ARQ - ACK} for the UE to use if the UE multiplexes up to 11 ,$
and more than 11 combined information bits, respectively.

In some embodiments, one or more new RRC parameters may be introduced as follows:
betaOffsetUTO-UCI: Beta offset for UTO-UCI in CG-PUSCH.
uto-UCI-Multiplexing: If present, this field indicates that in the case of PUCCH overlapping with CG-PUSCH(s) within a PUCCH group, the UTO-UCI and HARQ-ACK are jointly encoded.
uto-UCI-and-CG-UCI-Multiplexing: If present, this field indicates that in the case of PUCCH overlapping with CG-PUSCH(s) within a PUCCH group, UTO-UCI, CG-UCI and HARQ-ACK are jointly encoded.

In some embodiments, if the UE is configured with betaOffsetUTO-UCI, the UE may apply the rule (addition to Rel-17 3GPP TS 38.213, Clause 9.3) as shown in Table 11:

TABLE 11
Proposed Modification to Clause 9.3 of 3GPP TS 38.213

For a PUSCH transmission that is configured by a ConfiguredGrantConfig and
includes UTO-UCI, the UE multiplexes UTO-UCI in the PUSCH transmission if the
$UE is provided by betaOffsetUTO - UCI a {I}_{offset}^{UTO - UCI} value , from a set of values , with the$
mapping defined in Table 9.3-X. If the UE is provided uto-UCI-Multiplexing and
multiplexes HARQ-ACK information in the PUSCH transmission, as described in
clauses 9 and 9.2.5, the UE jointly encodes the HARQ-ACK information and the
UTO-UCI [5, TS 38.212] and determines a number of resources for multiplexing the
$combined information in a PUSCH using {β}_{offset}^{H ARQ - ACK} which provides indexes$
${I}_{offset , 1}^{H ARQ - ACK} and {I}_{offset , 2}^{H ARQ - ACK} for the UE to use if the UE multiplexes up to 11 , and more$
than 11 combined information bits, respectively.

In some examples, Table 9.3-X may be added to Clause 9.3 of 3GPP TS 38.213 as a new table for UTO-UCI defined or the same table (Table 9.3-1) used for CG-UCI may also be used for UTO-UCI.

In some embodiments, the UE cannot be configured with both betaOffsetUTO-UCI and betaOffsetCG-UCI when the UE is configured with cg-RetransmissionTimer and <unusedTosIndicator>. In some embodiments, betaOffsetUTO-UCI is configured but not betaOffsetCG-UCI, while in other embodiments betaOffsetCG-UCI is configured but not betaOffsetUTO-UCI. In such embodiments, the UE uses betaOffsetUTO-UCI or betaOffsetCG-UCI for both CG-UCI and UTO-UCI. For example, rules may apply such as:
If CG-UCI, UTO-UCI and HARQ-ACK is present, the UE uses the beta-offset for HARQ-ACK.
If CG-UCI and UTO-UCI is present but not HARQ-ACK, then UE uses betaOffsetUTO-UCI (or betaOffsetCG-UCI).
If UTO-UCI is present but not CG-UCI and HARQ-ACK, the UE uses betaOffsetUTO-UCI.
If CG-UCI is present but not UTO-UCI and HARQ-ACK, the UE uses betaOffsetCG-UCI

In some examples, the UE may further apply the rule (addition to Rel-17 3GPP TS 38.213, Clause 9.3) as shown in Table 12.

TABLE 12
Proposed Modification to Clause 9.3 of 3GPP TS 38.213:

If the UE is provided uto-UCI-and-CG-UCI-Multiplexing and multiplexes HARQ-
ACK information in the PUSCH transmission, as described in clauses 9 and 9.2.5, the
UE jointly encodes the HARQ-ACK information, CG-UCI [5, TS 38.212] and the
UTO-UCI [5, TS 38.212] and determines a number of resources for multiplexing the
$combined information in a PUSCH using {β}_{offset}^{H ARQ - ACK} which provides indexes$
${I}_{offset , 1}^{H ARQ - ACK} and {I}_{offset , 2}^{H ARQ - ACK} for the UE to use if the UE multiplexes up to 11 , and more$
than 11 combined information bits, respectively.

In some examples, when the UE is configured with uto-UCI-Multiplexing, the physical layer procedures may re-use Rel-17 procedures that apply for jointly encoding CG-UCI and HARQ-ACK. This may be achieved by slightly changing existing specifications by replacing “CG-UCI” with “CG-UCI or UTO-UCI”. For example, 3GPP TS 38.212, Clause 6.3.2.1.4 may be changed as highlighted in Table 13.

TABLE 13
Proposed Modification to Clause 6.3.2.1.4 of 3GPP TS 38.212

```
6.3.2.1.4 CG-UCI or UTO-UCI and HARQ-ACK
When only one of the higher layer parameter cg-UCI-Multiplexing or uto-UCI-Multiplexing is
configured, the UCI bit sequence a₀, a₁, a₂, a₃, . . . , a_{A-1} is determined as follows, where A =
O^{CG-UCI} + O^{ACK}.
    The CG-UCI or UTO-UCI bits are mapped to the UCI bit
    $sequence {a}_{0} , {a}_{1} , {a}_{2} , {a}_{3} , … , {a}_{{O}^{C G - UCI} - 1} , where {a}_{i} = {\tilde{o}}_{i}^{C G - UCI} for i = 0 , 1 , … , {O}^{C G - UCI} - 1 .$
    $The CG - UCI or UTO - UCI bit sequence {\tilde{o}}_{0}^{CG - UCI} , {\tilde{o}}_{1}^{CG - UCI} , … , {\tilde{o}}_{{O}^{CG - UCI} - 1}^{CG - UCI} is given by$
    Table 6.3.2.1.3-1 or Table 6.3.2.1.3-Y mapped in the order from upper part to lower
    part, and O^{CG-UCI} is number of CG-UCI bits or UTO-UCI bits;
    The HARQ-ACK bits are mapped to the UCI bit sequence a_{O}_{^{CG-UCI}}, a_{O}_{^{CG-UCI}}_{₊₁},
    $… , {a}_{{O}^{C G - UCI} + {O}^{ACK} - 1} , where {a}_{i + {O}^{C G - UCI}} = {\tilde{o}}_{i}^{A C K} for i = 0 , 1 , … , {O}^{A C K} - 1. The HARQ -$
    $ACK bit sequence {\tilde{o}}_{0}^{ACK} , {\tilde{o}}_{1}^{ACK} , … , {\tilde{o}}_{{O}^{A C K} - 1}^{A C K} is given by Clause 9.1 of [ 5 , TS 38.213 ] , and$
    O^{ACK} is number of HARQ-ACK bits.
```

Table 6.3.2.1.3-Y may be added according to Table 4.

In some examples, when the UE is configured with uto-UCI-and-CG-UCI-Multiplexing, the physical layer procedures include a procedure to determine the UCI bit sequence from CG-UC, UTO-UCI and HARQ-ACK bits. This procedure may be included as a new clause in 3GPP TS 38.212 as shown in Table 14.

TABLE 14
Proposed Modification to Clause 6.3.2.1.y of 3GPP TS 38.212

```
6.3.2.1.y CG-UCI, UTO-UCI and HARQ-ACK
When higher layer parameter uto-UCI-and-CG-UCI-Multiplexing is configured, the UCI
bit sequence a₀, a₁, a₂, a₃, . . . , a1 is determined as follows, where A = O^{CG-UCI} + O^{UTO-UCI} + O^{ACK}.
    The CG-UCI bits are mapped to the UCI bit sequenced a₀, a₁, a₂, a₃, . . . , a_{O}_{^{CG-UCI}}_{_{−1}},
    $where {a}_{i} = {\tilde{o}}_{i}^{C G - UCI} for i = 0 , 1 , … , {O}^{C G - UCI} - 1 . The CG - UCI bit sequence$
    ${\tilde{o}}_{0}^{CG - CGI} , {\tilde{o}}_{1}^{CG - UCI} , … , {\tilde{o}}_{{O}^{C G - U C} - 1}^{CG - UCI} is given by Table 6.3 \text{.2} \text{.1} \text{.3} - 1 mapped in the order$
    from upper part to lower part, and O^{CG-UCI} is number of CG-UCI bits;
    The UTO-UCI bits are mapped to the UCI bit
    $sequence {a}_{0} , {a}_{1} , {a}_{2} , {a}_{3} , … , {a}_{{O}^{UTO - UCI} - 1} , where {a}_{i} = {\tilde{o}}_{i}^{UTO - UCI} for i =$
    $0 , 1 , … , {O}^{UTO - UCI} - 1. The UTO - UCI bit sequence {\tilde{o}}_{0}^{CG - UCI} , {\tilde{o}}_{1}^{CG - UCI} , … , {\tilde{o}}_{{O}^{UTO - UCI} - 1}^{UTO - UCI}$
    is given by Table 6.3.2.1.3-Y mapped in the order from upper part to lower part,
    and O^{UTO-UCI} is number of CG-UCI bits;
    The HARQ-ACK bits are mapped to the UCI bit sequence aₒ_{^{CG-UCI, a}}_{O}_{^{CG-UCI}}_{₊₁},
    $… , {a}_{{O}^{C G - UCI} + {O}^{UTO - UCI} + {O}^{ACK} - 1} , where {a}_{i + {O}^{C G - UCI}} = {\tilde{o}}_{i}^{UTO - UCI} for i =$
    $0 , 1 , … , {O}^{UTO - UCI} - 1 and {a}_{i + {O}^{CG - UCI} + {O}^{UTO - UCI}} = {\tilde{o}}_{i}^{ACK} for i = 0 , 1 , … , {O}^{ACK} - 1. The$
    $HARQ - ACK bit sequence {\tilde{o}}_{0}^{ACK} , {\tilde{o}}_{1}^{ACK} , … , {\tilde{o}}_{{O}^{A C K} - 1}^{A C K} is given by Clause 9.1 of [ 5 ,$
    TS38.213], and O^{ACK} is number of HARQ-ACK bits.
```

In some examples, Clause 6.3.2.1.4 of 3GPP TS 38.212 may be modified to include UTO-UCI, if present, as shown in Table 15.

TABLE 15
Proposed Modification to Clause 6.3.2.1.4 of 3GPP TS 38.212

6.3.2.1.4 CG-UCI or UTO-UCI and HARQ-ACK
When higher layer parameter cg-UCI-Multiplexing or uto-UCI-Multiplexing is
configured, the UCI bit sequence a₀, a₁, a₂, a₃, . . . , a_{A-1} is determined as follows, where
A = O^{CG-UCI} + O^{UTO-UCI} + O^{ACK}. If cg-UCI-Multiplexing or uto-UCI-Multiplexing is not configured,
then O^{CG-UCI} = 0 or O^{UTO-UCI} = 0, respectively.
If cg-UCI-Multiplexing is configured, the CG-UCI bits are mapped to the UCI bit
$sequence {a}_{0} , {a}_{1} , {a}_{2} , {a}_{3} , … , {a}_{{O}^{C G - UCI} - 1} , where {a}_{i} = {\tilde{o}}_{i}^{C G - UCI} for i = 0 , 1 , … , {O}^{C G - UCI} -$
$1. The CG - UCI bit sequence {\tilde{o}}_{0}^{CG - UCI} , {\tilde{o}}_{1}^{CG - UCI} , … , {\tilde{o}}_{{O}^{CG - UCI} - 1}^{CG - UCI} is given by Table$
6.3.2.1.3-1 mapped in the order from upper part to lower part, and O^{CG-UCI} is
number of CG-UCI bits;
If uto-UCI-Multiplexing is configured, the UTO-UCI bits are mapped to the UCI bit
$sequence {a}_{0} , {a}_{1} , {a}_{2} , {a}_{3} , … , {a}_{{O}^{UTO - UCI} - 1} , where {a}_{i} = {\tilde{o}}_{i}^{UTO - UCI} for i =$
$0 , 1 , … , {O}^{UTO - UCI} - 1. The UTO - UCI bit sequence {\tilde{o}}_{0}^{CG - UCI} , {\tilde{o}}_{1}^{CG - UCI} , … , {\tilde{o}}_{{O}^{UTO - UCI} - 1}^{UTO - UCI}$
is given by Table 6.3.2.1.3-Y mapped in the order from upper part to lower part, and O^{UTO-UCI} is
number of CG-UCI bits;
The HARQ-ACK bits are mapped to the UCI bit sequence a_{O}_{^{CG-UCI}}, a_{O}_{^{CG-UCI}}_{₊₁},
$… , {a}_{{O}^{C G - UCI} + {O}^{UTO - UCI} + {O}^{ACK} - 1} , where {a}_{i + {O}^{C G - UCI}} = {\tilde{o}}_{i}^{UTO - UCI} for i =$
$0 , 1 , … , {O}^{UTO - UCI} - 1 and {a}_{i + {O}^{CG - UCI} + {O}^{UTO - UCI}} = {\tilde{o}}_{i}^{ACK} for i = 0 , 1 , … , {O}^{ACK} - 1. The$
$HARQ - ACK bit sequence {\tilde{o}}_{0}^{ACK} , {\tilde{o}}_{1}^{ACK} , … , {\tilde{o}}_{{O}^{A C K} - 1}^{A C K} is given by Clause 9.1 of [ 5 ,$
TS38.213], and O^{ACK} is number of HARQ-ACK bits.

In some examples, the mapping order for CG-UCI, UTO-UCI and HARQ-ACK bits may be different. A person skilled in the should perform the appropriate changes if, for example, UTO-UCI is put before CG-UCI in the UCI bit sequence above.

In some embodiments, the UE is not configured with uto-UCI-and-CG-UCI-Multiplexing, but is configured with both uto-UCI-Multiplexing and cg-UCI-Multiplexing wherein the UE applies physical layer procedure to jointly encode CG-UCI, UTO-UCI and HARQ-ACK.

In some embodiments, the priority index of UTO-UCI is the same priority index as CG-PUSCH.

In some embodiments, the UE is configured to transmit UTO-UCI on a PUSCH different from CG-PUSCH. For example, the UE may be configured with a semi-persistent PUSCH similar to semi-persistent CSI on PUSCH. In such examples, the UE may be configured with a CS-UTO-RNTI to be used when activating semi-persistent reporting of unused TOs.

In some embodiments, UTO-UCI is not jointly encoded with CG-UCI and/or HARQ-ACK. In such embodiments, a procedure for encoding UTO-UCI may follow the procedures for CSI Type 1 or CSI Type 2 and a betaOffsetUTO-UCI may be used as beta-offset for UTO-UCI while CG-UCI and or HARQ-ACK uses beta-offset for CG-UCI or HARQ-ACK as in Rel-17.

### UTO-UCI as Higher Layer Signaling

In some embodiments, the signaling of UTO-UCI uses higher layer signaling, such as a MAC control element or RRC signaling.

In some embodiments, the UTO-UCI is forwarded from one network node to another, for example in preparation for handover.

In further embodiments, the MAC subhead of the MAC PDU can include an indication of ‘end of data’. When a UE includes this, it will not use any remaining TOs in a certain duration which can be either until the next period of configured grants or until pre-determined duration. The gNB may reuse the remaining TOs defined in the same way as UE will not use. If the MAC subheader does not include ‘end of data’, the gNB will assume that the remaining TOs will be used by the UE.

### CG-UCI as Implicit UTO-UCI Indication

In some embodiments, if UE is configured with <unusedTosIndicator>, sending CG-UCI can be considered as an implicit indication of unused TOs. For example, if a UE with configured <unusedTosIndicator> sends CG-UCI in the time t, all remaining TOs after time t before the certain time instance which is preconfigured by higher layers will be unused. The time instance can be the time that the next period of configure grant starts. Once the gNB receives CG-UCI, it shall consider that all remaining TOs until the configured time instance can be reused. The other type of existing UCIs, e.g., UCI for HARQ ACK/NACK, scheduling request, CSI report can be also used for this implicit indication both via PUSCH or PUCCH.

### UTO-UCI for Multiple Configured Grant Configurations

If more than one configured grant is configured by a network, all above UTO-UCI indications can be applied for configured multiple configured grants. Each configured grant will have its own UTO-UCI to indicate unused TOs in the corresponding configured grant. In another way, one UTO-UCI can be transmitted for more than one configured grant.

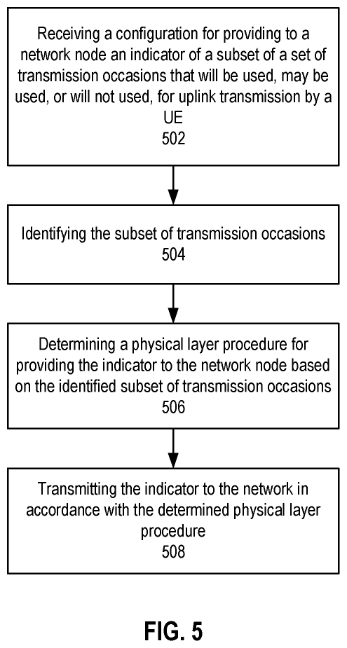

Operations of a UE according to some embodiments are illustrated in FIG. 5. Referring to FIG. 5, a method performed by a UE in a wireless communication network includes receiving a configuration for providing, to a network node in the wireless communication network, an indicator of a subset of a set of transmission occasions that are configured for the UE for performing uplink transmission (block 502). The subset of transmission occasions corresponds to transmission occasions, within the set of transmission occasions, that will all be used, may be used, or will be unused, by the UE to perform uplink transmission. The method further includes identifying the subset of transmission occasions (block 504), determining a physical layer procedure for providing the indicator to the network node based on the identified subset of transmission occasions (block 506), and transmitting the indicator that indicates the identified subset of transmission occasions to the network node in accordance with the determined physical layer procedure (block 508).

The physical layer procedure may include determining a timing condition based on the identified subset of transmission occasions.

Determining the timing condition may include determining a timing condition for a dynamically scheduled PUSCH transmission based on the indicator.

In some embodiments, the physical layer procedure may include determining a slot format indicator restriction based on the identified subset of transmission occasions. The slot format indicator may indicate that a set of symbols of a slot, that is indicated by the indicator as being unused by the UE for uplink transmission, is a downlink or flexible slot.

The physical layer procedure may include generating UTO-UCI, multiplexing the UTO-UCI with other UCI to provide multiplexed UCI, and transmitting the multiplexed UCI to the network node. The multiplexed UCI may be transmitted to the network node using a PUSCH.

In some embodiments, a priority index of the UTO-UCI is the same as a priority index of a configured grant PUSCH transmission.

In some embodiments, each configured grant PUSCH transmitted in a transmission occasion in the set of transmission occasions includes UTO-UCI.

In some embodiments, UTO-UCI is jointly encoded with hybrid automatic repeat request, HARQ, information.

In some embodiments, indicator that indicates the identified subset of transmission occasions may be an unused transmission occasion, UTO, indicator, and the physical layer procedure may include receiving the UTO indicator from a higher layer of a protocol stack within the UE.

The physical layer procedure may include selecting the UTO indicator from a set of UTO indicators configured by the higher layer.

Transmitting the indicator may be performed in a physical uplink shared channel, PUSCH, transmission in a configured grant that corresponds to one of the transmission occasions in the set of transmission occasions.

The physical layer procedure may include determining a periodicity with which to transmit the indicator. The periodicity of transmission of the indicator may be different than a periodicity of the transmission occasions.

In some embodiments, the physical layer procedure includes determining a RRC parameter to use when transmitting the indicator. The RRC parameter may include a beta offset parameter. The beta offset parameter may include a betaOffsetUTO-UCI parameter.

The set of transmission occasions may include a set of periodically repeating transmission occasions, and wherein the subset of the set of transmission occasions comprises a periodically repeating subset of the set transmission occasions.

The subset of transmission occasions may be determined based on an expected need for a periodically repeating uplink transmission requirement by a service operated by the UE. The service operated by the UE may include an extended reality, XR, service, and the periodically repeating uplink transmission requirement may include a requirement to perform uplink transmission of XR frames at a predetermined frame rate.

The subset of transmission occasions may include transmission occasions in which the UE will not perform uplink transmission, and the method may further include refraining from performing uplink transmission during the subset of transmission occasions.

In some embodiments, the subset of transmission occasions may include transmission occasions in which the UE will perform uplink transmission, and the method may further include refraining from performing uplink transmission during the transmission occasions in the set of transmission occasions other than transmission occasions in the subset of transmission occasions.

The method may further include receiving, from the wireless communication network, a configured grant that configures the UE with the set of transmission occasions for performing uplink transmission.

The method may further include receiving a confirmation of the indicator from the wireless communication network.

Transmitting the indicator to the wireless communication network may include transmitting the indicator in a UCI message.

Transmitting the indicator that indicates the identified subset of transmission occasions may be performed in response to a command by a higher protocol layer, or a medium access control protocol layer.

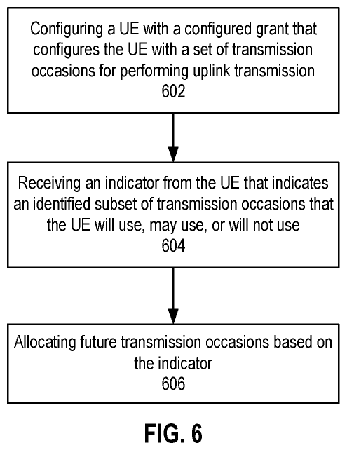

Operations of a network node according to some embodiments are illustrated in FIG. 6. Referring to FIG. 6, a method performed by a network node of a wireless communication network includes configuring a UE with a configured grant that configures the UE with a set of transmission occasions for performing uplink transmission (block 602), and receiving an indicator from the UE indicating a subset of the set of transmission occasions that are configured for the UE for performing uplink transmission (block 604). The subset of transmission occasions corresponds to transmission occasions, within the set of transmission occasions, that will all be used, may be used, or will be unused, by the UE to perform uplink transmission. The method further includes scheduling future transmissions and/or receptions in the set of transmission occasions based on the indicator (block 606).

The method may further include transmitting an acknowledgement message to the UE acknowledging the indicator in response to receiving the indicator.

The indicator may indicate that the subset of the set of transmission occasions will not be used by the UE for performing uplink transmission, and the method may further include re-allocating a transmission occasion in the subset of the set of transmission occasions to another UE.

In some embodiments, the indicator indicates that only the subset of the set of transmission occasions will be used by the UE for performing uplink transmission, and the method further includes re-allocating transmission occasions in the set of transmission occasions, other than those transmission occasions in the subset of the set of transmission occasions, to another UE.

The method may further include configuring the UE to provide the indicator indicating the subset of transmission occasions, within the set of transmission occasions, that will all be used, may be used, or will be unused, by the UE to perform uplink transmission.

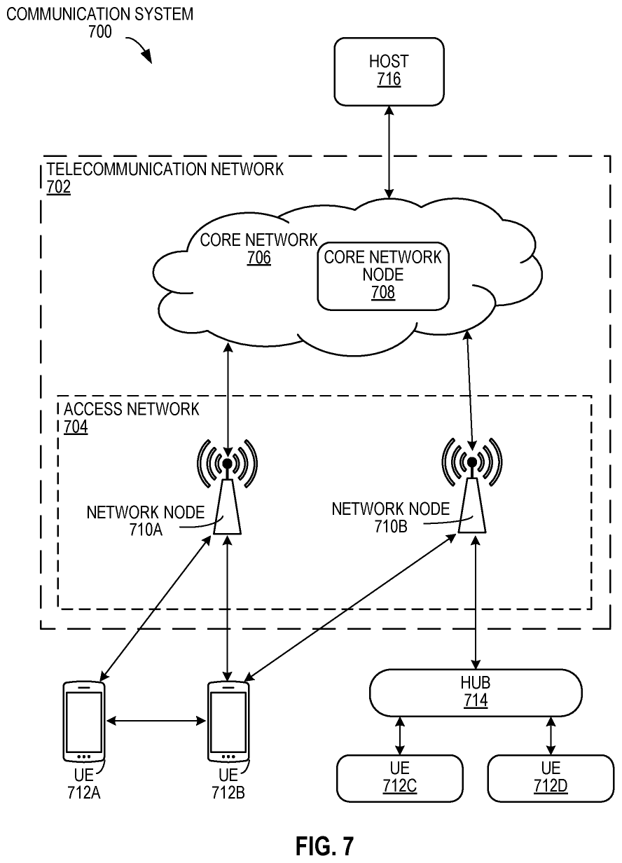

FIG. 7 shows an example of a communication system 700 in accordance with some embodiments.

In the example, the communication system 700 includes a telecommunication network 702 that includes an access network 704, such as a radio access network (RAN), and a core network 706, which includes one or more core network nodes 708. The access network 704 includes one or more access network nodes, such as network nodes 710a and 710b (one or more of which may be generally referred to as network nodes 710), or any other similar 3^{rd} Generation Partnership Project (3GPP) access node or non-3GPP access point. The network nodes 710 facilitate direct or indirect connection of user equipment (UE), such as by connecting UEs 712a, 712b, 712c, and 712d (one or more of which may be generally referred to as UEs 712) to the core network 706 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 700 may include any number of wired or wireless networks, network nodes, UEs, and/or any other components or systems that may facilitate or participate in the communication of data and/or signals whether via wired or wireless connections. The communication system 700 may include and/or interface with any type of communication, telecommunication, data, cellular, radio network, and/or other similar type of system.

The UEs 712 may be any of a wide variety of communication devices, including wireless devices arranged, configured, and/or operable to communicate wirelessly with the network nodes 710 and other communication devices. Similarly, the network nodes 710 are arranged, capable, configured, and/or operable to communicate directly or indirectly with the UEs 712 and/or with other network nodes or equipment in the telecommunication network 702 to enable and/or provide network access, such as wireless network access, and/or to perform other functions, such as administration in the telecommunication network 702.

In the depicted example, the core network 706 connects the network nodes 710 to one or more hosts, such as host 716. These connections may be direct or indirect via one or more intermediary networks or devices. In other examples, network nodes may be directly coupled to hosts. The core network 706 includes one more core network nodes (e.g., core network node 708) that are structured with hardware and software components. Features of these components may be substantially similar to those described with respect to the UEs, network nodes, and/or hosts, such that the descriptions thereof are generally applicable to the corresponding components of the core network node 708. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), and/or a User Plane Function (UPF).

The host 716 may be under the ownership or control of a service provider other than an operator or provider of the access network 704 and/or the telecommunication network 702, and may be operated by the service provider or on behalf of the service provider. The host 716 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 700 of FIG. 7 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, the telecommunication network 702 is a cellular network that implements 3GPP standardized features. Accordingly, the telecommunications network 702 may support network slicing to provide different logical networks to different devices that are connected to the telecommunication network 702. For example, the telecommunications network 702 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, the UEs 712 are configured to transmit and/or receive information without direct human interaction. For instance, a UE may be designed to transmit information to the access network 704 on a predetermined schedule, when triggered by an internal or external event, or in response to requests from the access network 704. Additionally, a UE may be configured for operating in single- or multi-RAT or multi-standard mode. For example, a UE may operate with any one or combination of Wi-Fi, NR (New Radio) and LTE, i.e. being configured for multi-radio dual connectivity (MR-DC), such as E-UTRAN (Evolved-UMTS Terrestrial Radio Access Network) New Radio—Dual Connectivity (EN-DC).

In the example, the hub 714 communicates with the access network 704 to facilitate indirect communication between one or more UEs (e.g., UE 712c and/or 712d) and network nodes (e.g., network node 710b). In some examples, the hub 714 may be a controller, router, content source and analytics, or any of the other communication devices described herein regarding UEs. For example, the hub 714 may be a broadband router enabling access to the core network 706 for the UEs. As another example, the hub 714 may be a controller that sends commands or instructions to one or more actuators in the UEs. Commands or instructions may be received from the UEs, network nodes 710, or by executable code, script, process, or other instructions in the hub 714. As another example, the hub 714 may be a data collector that acts as temporary storage for UE data and, in some embodiments, may perform analysis or other processing of the data. As another example, the hub 714 may be a content source. For example, for a UE that is a VR headset, display, loudspeaker or other media delivery device, the hub 714 may retrieve VR assets, video, audio, or other media or data related to sensory information via a network node, which the hub 714 then provides to the UE either directly, after performing local processing, and/or after adding additional local content. In still another example, the hub 714 acts as a proxy server or orchestrator for the UEs, in particular in if one or more of the UEs are low energy IoT devices.

The hub 714 may have a constant/persistent or intermittent connection to the network node 710b. The hub 714 may also allow for a different communication scheme and/or schedule between the hub 714 and UEs (e.g., UE 712c and/or 712d), and between the hub 714 and the core network 706. In other examples, the hub 714 is connected to the core network 706 and/or one or more UEs via a wired connection. Moreover, the hub 714 may be configured to connect to an M2M service provider over the access network 704 and/or to another UE over a direct connection. In some scenarios, UEs may establish a wireless connection with the network nodes 710 while still connected via the hub 714 via a wired or wireless connection. In some embodiments, the hub 714 may be a dedicated hub—that is, a hub whose primary function is to route communications to/from the UEs from/to the network node 710b. In other embodiments, the hub 714 may be a non-dedicated hub—that is, a device which is capable of operating to route communications between the UEs and network node 710b, but which is additionally capable of operating as a communication start and/or end point for certain data channels.

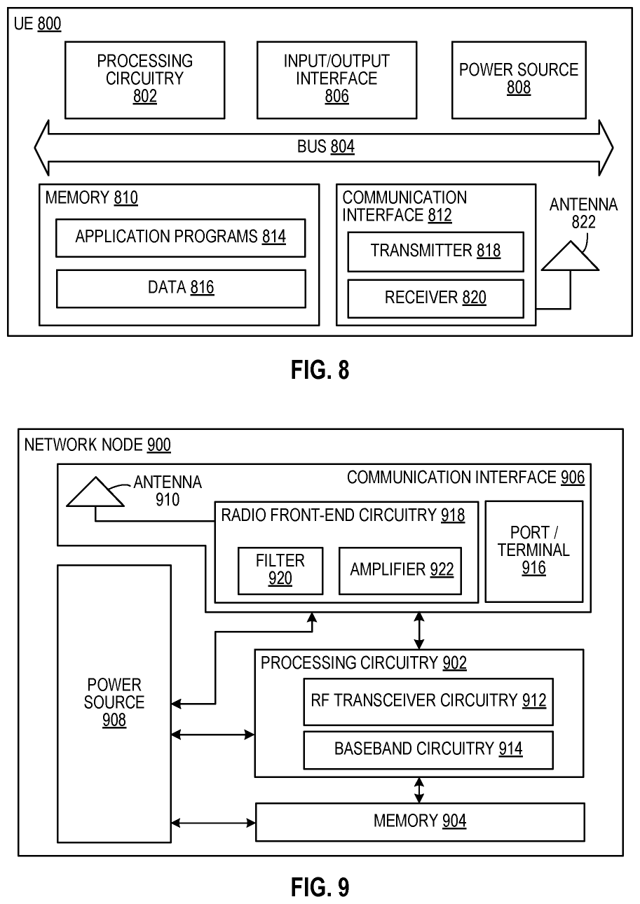

FIG. 8 shows a UE 800 in accordance with some embodiments. As used herein, a UE refers to a device capable, configured, arranged and/or operable to communicate wirelessly with network nodes and/or other UEs. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by the 3rd Generation Partnership Project (3GPP), including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 800 includes processing circuitry 802 that is operatively coupled via a bus 804 to an input/output interface 806, a power source 808, a memory 810, a communication interface 812, and/or any other component, or any combination thereof. Certain UEs may utilize all or a subset of the components shown in FIG. 8. The level of integration between the components may vary from one UE to another UE. Further, certain UEs may contain multiple instances of a component, such as multiple processors, memories, transceivers, transmitters, receivers, etc.

The processing circuitry 802 is configured to process instructions and data and may be configured to implement any sequential state machine operative to execute instructions stored as machine-readable computer programs in the memory 810. The processing circuitry 802 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, the processing circuitry 802 may include multiple central processing units (CPUs).

In the example, the input/output interface 806 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 800. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 808 is structured as a battery or battery pack. Other types of power sources, such as an external power source (e.g., an electricity outlet), photovoltaic device, or power cell, may be used. The power source 808 may further include power circuitry for delivering power from the power source 808 itself, and/or an external power source, to the various parts of the UE 800 via input circuitry or an interface such as an electrical power cable. Delivering power may be, for example, for charging of the power source 808. Power circuitry may perform any formatting, converting, or other modification to the power from the power source 808 to make the power suitable for the respective components of the UE 800 to which power is supplied.

The memory 810 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, the memory 810 includes one or more application programs 814, such as an operating system, web browser application, a widget, gadget engine, or other application, and corresponding data 816. The memory 810 may store, for use by the UE 800, any of a variety of various operating systems or combinations of operating systems.

The memory 810 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ The memory 810 may allow the UE 800 to access instructions, application programs and the like, stored on transitory or non-transitory memory media, to off-load data, or to upload data. An article of manufacture, such as one utilizing a communication system may be tangibly embodied as or in the memory 810, which may be or comprise a device-readable storage medium.

The processing circuitry 802 may be configured to communicate with an access network or other network using the communication interface 812. The communication interface 812 may comprise one or more communication subsystems and may include or be communicatively coupled to an antenna 822. The communication interface 812 may include one or more transceivers used to communicate, such as by communicating with one or more remote transceivers of another device capable of wireless communication (e.g., another UE or a network node in an access network). Each transceiver may include a transmitter 818 and/or a receiver 820 appropriate to provide network communications (e.g., optical, electrical, frequency allocations, and so forth). Moreover, the transmitter 818 and receiver 820 may be coupled to one or more antennas (e.g., antenna 822) and may share circuit components, software or firmware, or alternatively be implemented separately.

In the illustrated embodiment, communication functions of the communication interface 812 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 812, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 800 shown in FIG. 8.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g. by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 9 shows a network node 900 in accordance with some embodiments. As used herein, network node refers to equipment capable, configured, arranged and/or operable to communicate directly or indirectly with a UE and/or with other network nodes or equipment, in a telecommunication network. Examples of network nodes include, but are not limited to, access points (APs) (e.g., radio access points), base stations (BSs) (e.g., radio base stations, Node Bs, evolved Node Bs (eNBs) and NR NodeBs (gNBs)).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 900 includes a processing circuitry 902, a memory 904, a communication interface 906, and a power source 908. The network node 900 may be composed of multiple physically separate components (e.g., a NodeB component and a RNC component, or a BTS component and a BSC component, etc.), which may each have their own respective components. In certain scenarios in which the network node 900 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, the network node 900 may be configured to support multiple radio access technologies (RATs). In such embodiments, some components may be duplicated (e.g., separate memory 904 for different RATs) and some components may be reused (e.g., a same antenna 910 may be shared by different RATs). The network node 900 may also include multiple sets of the various illustrated components for different wireless technologies integrated into network node 900, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 900.

The processing circuitry 902 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 900 components, such as the memory 904, to provide network node 900 functionality.

In some embodiments, the processing circuitry 902 includes a system on a chip (SOC). In some embodiments, the processing circuitry 902 includes one or more of radio frequency (RF) transceiver circuitry 912 and baseband processing circuitry 914. In some embodiments, the radio frequency (RF) transceiver circuitry 912 and the baseband processing circuitry 914 may be on separate chips (or sets of chips), boards, or units, such as radio units and digital units. In alternative embodiments, part or all of RF transceiver circuitry 912 and baseband processing circuitry 914 may be on the same chip or set of chips, boards, or units.

The memory 904 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by the processing circuitry 902. The memory 904 may store any suitable instructions, data, or information, including a computer program, software, an application including one or more of logic, rules, code, tables, and/or other instructions capable of being executed by the processing circuitry 902 and utilized by the network node 900. The memory 904 may be used to store any calculations made by the processing circuitry 902 and/or any data received via the communication interface 906. In some embodiments, the processing circuitry 902 and memory 904 is integrated.

The communication interface 906 is used in wired or wireless communication of signaling and/or data between a network node, access network, and/or UE. As illustrated, the communication interface 906 comprises port(s)/terminal(s) 916 to send and receive data, for example to and from a network over a wired connection. The communication interface 906 also includes radio front-end circuitry 918 that may be coupled to, or in certain embodiments a part of, the antenna 910. Radio front-end circuitry 918 comprises filters 920 and amplifiers 922. The radio front-end circuitry 918 may be connected to an antenna 910 and processing circuitry 902. The radio front-end circuitry may be configured to condition signals communicated between antenna 910 and processing circuitry 902. The radio front-end circuitry 918 may receive digital data that is to be sent out to other network nodes or UEs via a wireless connection. The radio front-end circuitry 918 may convert the digital data into a radio signal having the appropriate channel and bandwidth parameters using a combination of filters 920 and/or amplifiers 922. The radio signal may then be transmitted via the antenna 910. Similarly, when receiving data, the antenna 910 may collect radio signals which are then converted into digital data by the radio front-end circuitry 918. The digital data may be passed to the processing circuitry 902. In other embodiments, the communication interface may comprise different components and/or different combinations of components.

In certain alternative embodiments, the network node 900 does not include separate radio front-end circuitry 918, instead, the processing circuitry 902 includes radio front-end circuitry and is connected to the antenna 910. Similarly, in some embodiments, all or some of the RF transceiver circuitry 912 is part of the communication interface 906. In still other embodiments, the communication interface 906 includes one or more ports or terminals 916, the radio front-end circuitry 918, and the RF transceiver circuitry 912, as part of a radio unit (not shown), and the communication interface 906 communicates with the baseband processing circuitry 914, which is part of a digital unit (not shown).

The antenna 910 may include one or more antennas, or antenna arrays, configured to send and/or receive wireless signals. The antenna 910 may be coupled to the radio front-end circuitry 918 and may be any type of antenna capable of transmitting and receiving data and/or signals wirelessly. In certain embodiments, the antenna 910 is separate from the network node 900 and connectable to the network node 900 through an interface or port.

The antenna 910, communication interface 906, and/or the processing circuitry 902 may be configured to perform any receiving operations and/or certain obtaining operations described herein as being performed by the network node. Any information, data and/or signals may be received from a UE, another network node and/or any other network equipment. Similarly, the antenna 910, the communication interface 906, and/or the processing circuitry 902 may be configured to perform any transmitting operations described herein as being performed by the network node. Any information, data and/or signals may be transmitted to a UE, another network node and/or any other network equipment.

The power source 908 provides power to the various components of network node 900 in a form suitable for the respective components (e.g., at a voltage and current level needed for each respective component). The power source 908 may further comprise, or be coupled to, power management circuitry to supply the components of the network node 900 with power for performing the functionality described herein. For example, the network node 900 may be connectable to an external power source (e.g., the power grid, an electricity outlet) via an input circuitry or interface such as an electrical cable, whereby the external power source supplies power to power circuitry of the power source 908. As a further example, the power source 908 may comprise a source of power in the form of a battery or battery pack which is connected to, or integrated in, power circuitry. The battery may provide backup power should the external power source fail.

Embodiments of the network node 900 may include additional components beyond those shown in FIG. 9 for providing certain aspects of the network node's functionality, including any of the functionality described herein and/or any functionality necessary to support the subject matter described herein. For example, the network node 900 may include user interface equipment to allow input of information into the network node 900 and to allow output of information from the network node 900. This may allow a user to perform diagnostic, maintenance, repair, and other administrative functions for the network node 900.

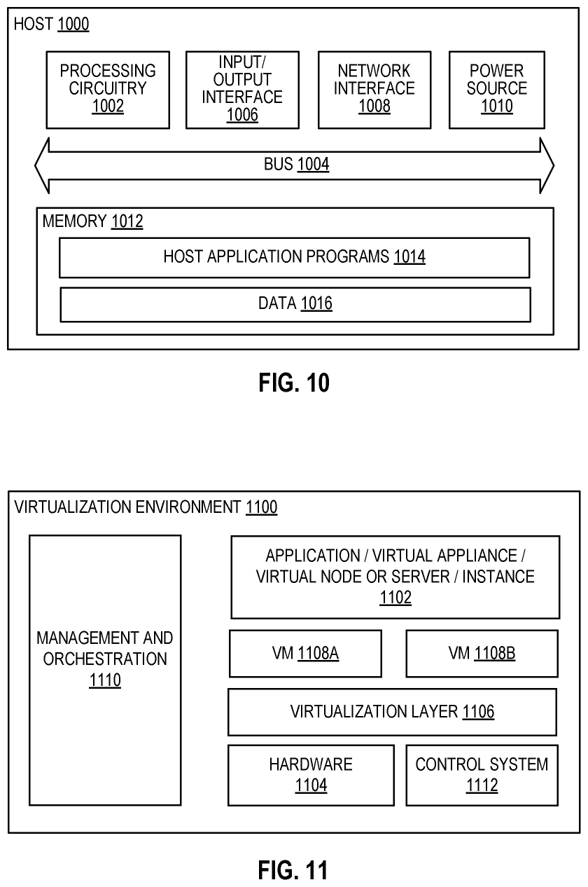

FIG. 10 is a block diagram of a host 1000, which may be an embodiment of the host 716 of FIG. 7, in accordance with various aspects described herein. As used herein, the host 1000 may be or comprise various combinations hardware and/or software, including a standalone server, a blade server, a cloud-implemented server, a distributed server, a virtual machine, container, or processing resources in a server farm. The host 1000 may provide one or more services to one or more UEs.

The host 1000 includes processing circuitry 1002 that is operatively coupled via a bus 1004 to an input/output interface 1006, a network interface 1008, a power source 1010, and a memory 1012. Other components may be included in other embodiments. Features of these components may be substantially similar to those described with respect to the devices of previous figures, such as FIGS. 8 and 9, such that the descriptions thereof are generally applicable to the corresponding components of host 1000.

The memory 1012 may include one or more computer programs including one or more host application programs 1014 and data 1016, which may include user data, e.g., data generated by a UE for the host 1000 or data generated by the host 1000 for a UE. Embodiments of the host 1000 may utilize only a subset or all of the components shown. The host application programs 1014 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). The host application programs 1014 may also provide for user authentication and licensing checks and may periodically report health, routes, and content availability to a central node, such as a device in or on the edge of a core network. Accordingly, the host 1000 may select and/or indicate a different host for over-the-top services for a UE. The host application programs 1014 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 11 is a block diagram illustrating a virtualization environment 1100 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in one or more virtual environments 1100 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1102 (which may alternatively be called software instances, virtual appliances, network functions, virtual nodes, virtual network functions, etc.) are run in the virtualization environment Q400 to implement some of the features, functions, and/or benefits of some of the embodiments disclosed herein.

Hardware 1104 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1106 (also referred to as hypervisors or virtual machine monitors (VMMs)), provide VMs 1108a and 1108b (one or more of which may be generally referred to as VMs 1108), and/or perform any of the functions, features and/or benefits described in relation with some embodiments described herein. The virtualization layer 1106 may present a virtual operating platform that appears like networking hardware to the VMs 1108.

The VMs 1108 comprise virtual processing, virtual memory, virtual networking or interface and virtual storage, and may be run by a corresponding virtualization layer 1106. Different embodiments of the instance of a virtual appliance 1102 may be implemented on one or more of VMs 1108, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, a VM 1108 may be a software implementation of a physical machine that runs programs as if they were executing on a physical, non-virtualized machine. Each of the VMs 1108, and that part of hardware 1104 that executes that VM, be it hardware dedicated to that VM and/or hardware shared by that VM with others of the VMs, forms separate virtual network elements. Still in the context of NFV, a virtual network function is responsible for handling specific network functions that run in one or more VMs 1108 on top of the hardware 1104 and corresponds to the application 1102.

Hardware 1104 may be implemented in a standalone network node with generic or specific components. Hardware 1104 may implement some functions via virtualization. Alternatively, hardware 1104 may be part of a larger cluster of hardware (e.g. such as in a data center or CPE) where many hardware nodes work together and are managed via management and orchestration 1110, which, among others, oversees lifecycle management of applications 1102. In some embodiments, hardware 1104 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of a control system 1112 which may alternatively be used for communication between hardware nodes and radio units.

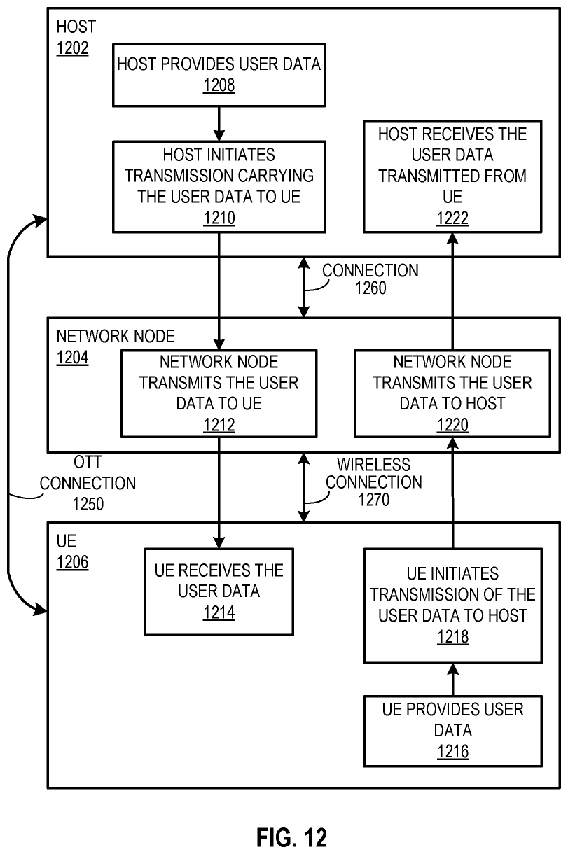

FIG. 12 shows a communication diagram of a host 1202 communicating via a network node 1204 with a UE 1206 over a partially wireless connection in accordance with some embodiments. Example implementations, in accordance with various embodiments, of the UE (such as a UE 712a of FIG. 7 and/or UE 800 of FIG. 8), network node (such as network node 710a of FIG. 7 and/or network node 900 of FIG. 9), and host (such as host 716 of FIG. 7 and/or host 1000 of FIG. 10) discussed in the preceding paragraphs will now be described with reference to FIG. 12.

Like host 1000, embodiments of host 1202 include hardware, such as a communication interface, processing circuitry, and memory. The host 1202 also includes software, which is stored in or accessible by the host 1202 and executable by the processing circuitry. The software includes a host application that may be operable to provide a service to a remote user, such as the UE 1206 connecting via an over-the-top (OTT) connection 1250 extending between the UE 1206 and host 1202. In providing the service to the remote user, a host application may provide user data which is transmitted using the OTT connection 1250.

The network node 1204 includes hardware enabling it to communicate with the host 1202 and UE 1206. The connection 1260 may be direct or pass through a core network (like core network 706 of FIG. 7) and/or one or more other intermediate networks, such as one or more public, private, or hosted networks. For example, an intermediate network may be a backbone network or the Internet.

The UE 1206 includes hardware and software, which is stored in or accessible by UE 1206 and executable by the UE's processing circuitry. The software includes a client application, such as a web browser or operator-specific “app” that may be operable to provide a service to a human or non-human user via UE 1206 with the support of the host 1202. In the host 1202, an executing host application may communicate with the executing client application via the OTT connection 1250 terminating at the UE 1206 and host 1202. In providing the service to the user, the UE's client application may receive request data from the host's host application and provide user data in response to the request data. The OTT connection 1250 may transfer both the request data and the user data. The UE's client application may interact with the user to generate the user data that it provides to the host application through the OTT connection 1250.

The OTT connection 1250 may extend via a connection 1260 between the host 1202 and the network node 1204 and via a wireless connection 1270 between the network node 1204 and the UE 1206 to provide the connection between the host 1202 and the UE 1206. The connection 1260 and wireless connection 1270, over which the OTT connection 1250 may be provided, have been drawn abstractly to illustrate the communication between the host 1202 and the UE 1206 via the network node 1204, without explicit reference to any intermediary devices and the precise routing of messages via these devices.

As an example of transmitting data via the OTT connection 1250, in step 1208, the host 1202 provides user data, which may be performed by executing a host application. In some embodiments, the user data is associated with a particular human user interacting with the UE 1206. In other embodiments, the user data is associated with a UE 1206 that shares data with the host 1202 without explicit human interaction. In step 1210, the host 1202 initiates a transmission carrying the user data towards the UE 1206. The host 1202 may initiate the transmission responsive to a request transmitted by the UE 1206. The request may be caused by human interaction with the UE 1206 or by operation of the client application executing on the UE 1206. The transmission may pass via the network node 1204, in accordance with the teachings of the embodiments described throughout this disclosure. Accordingly, in step 1212, the network node 1204 transmits to the UE 1206 the user data that was carried in the transmission that the host 1202 initiated, in accordance with the teachings of the embodiments described throughout this disclosure. In step 1214, the UE 1206 receives the user data carried in the transmission, which may be performed by a client application executed on the UE 1206 associated with the host application executed by the host 1202.

In some examples, the UE 1206 executes a client application which provides user data to the host 1202. The user data may be provided in reaction or response to the data received from the host 1202. Accordingly, in step 1216, the UE 1206 may provide user data, which may be performed by executing the client application. In providing the user data, the client application may further consider user input received from the user via an input/output interface of the UE 1206. Regardless of the specific manner in which the user data was provided, the UE 1206 initiates, in step 1218, transmission of the user data towards the host 1202 via the network node 1204. In step 1220, in accordance with the teachings of the embodiments described throughout this disclosure, the network node 1204 receives user data from the UE 1206 and initiates transmission of the received user data towards the host 1202. In step 1222, the host 1202 receives the user data carried in the transmission initiated by the UE 1206.

One or more of the various embodiments improve the performance of OTT services provided to the UE 1206 using the OTT connection 1250, in which the wireless connection 1270 forms the last segment. More precisely, the teachings of these embodiments may improve the data rate and/or latency of communications, particular XR communications, and thereby provide benefits such as improved user experience and better responsiveness.

In an example scenario, factory status information may be collected and analyzed by the host 1202. As another example, the host 1202 may process audio and video data which may have been retrieved from a UE for use in creating maps. As another example, the host 1202 may collect and analyze real-time data to assist in controlling vehicle congestion (e.g., controlling traffic lights). As another example, the host 1202 may store surveillance video uploaded by a UE. As another example, the host 1202 may store or control access to media content such as video, audio, VR or AR which it can broadcast, multicast or unicast to UEs. As other examples, the host 1202 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring the OTT connection 1250 between the host 1202 and UE 1206, in response to variations in the measurement results. The measurement procedure and/or the network functionality for reconfiguring the OTT connection may be implemented in software and hardware of the host 1202 and/or UE 1206. In some embodiments, sensors (not shown) may be deployed in or in association with other devices through which the OTT connection 1250 passes; the sensors may participate in the measurement procedure by supplying values of the monitored quantities exemplified above, or supplying values of other physical quantities from which software may compute or estimate the monitored quantities. The reconfiguring of the OTT connection 1250 may include message format, retransmission settings, preferred routing etc.; the reconfiguring need not directly alter the operation of the network node 1204. Such procedures and functionalities may be known and practiced in the art. In certain embodiments, measurements may involve proprietary UE signaling that facilitates measurements of throughput, propagation times, latency and the like, by the host 1202. The measurements may be implemented in that software causes messages to be transmitted, in particular empty or ‘dummy’ messages, using the OTT connection 1250 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions and methods disclosed herein. Determining, calculating, obtaining or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box, or nested within multiple boxes, in practice, computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored on in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hard-wired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole, and/or by end users and a wireless network generally.

### REFERENCES

[1] 3GPP TS 38.321 v17.3.0 (2023 January)
[2] 3GPP TS 38.214 v17.4.0 (2023 January)
[3] 3GPP TS 38.213 v17.4.0 (2023 January)
[4] 3GPP TS 38.212 v17.4.0 (2022 December)

1. A method performed by a user equipment, UE, in a wireless communication network, comprising:
receiving a configuration for providing, to a network node in the wireless communication network, an indicator of a subset of a set of transmission occasions that are configured for the UE for performing uplink transmission, the subset of transmission occasions corresponding to transmission occasions, within the set of transmission occasions, that will all be used, may be used, or will be unused, by the UE to perform uplink transmission;
identifying the subset of transmission occasions;
determining a physical layer procedure for providing the indicator to the network node based on the identified subset of transmission occasions; and
transmitting the indicator that indicates the identified subset of transmission occasions to the network node in accordance with the determined physical layer procedure.

2. The method of claim 1, wherein the physical layer procedure comprises determining a timing condition based on the identified subset of transmission occasions.

3. The method of claim 2, wherein determining the timing condition comprises determining a timing condition for a dynamically scheduled PUSCH transmission based on the indicator.

4. The method of claim 1, wherein the physical layer procedure comprises determining a slot format indicator restriction based on the identified subset of transmission occasions.

5. The method of claim 4, wherein a slot format indicator indicates that a set of symbols of a slot, that is indicated by the indicator as being unused by the UE for uplink transmission, is a downlink or flexible slot.

6. The method of claim 1, wherein the physical layer procedure comprises generating unused transmission occasion, UTO, uplink control information, UCI, UTO-UCI, including the indicator.

7. The method of claim 6, further comprising multiplexing the UTO-UCI with other UCI to provide multiplexed UCI, and transmitting the multiplexed UCI to the network node.

8. The method of claim 7, wherein the multiplexed UCI is transmitted to the network node using a physical uplink shared channel, PUSCH.

9. The method of claim 6, wherein a priority index of the UTO-UCI is the same as a priority index of a configured grant PUSCH transmission.

10. The method of claim 6, wherein each configured grant PUSCH transmitted in a transmission occasion in the set of transmission occasions includes UTO-UCI.

11. The method of claim 6, further comprising jointly encoding UTO-UCI with hybrid automatic repeat request, HARQ, information.

12. The method of claim 1, wherein the indicator that indicates the identified subset of transmission occasions comprises an unused transmission occasion, UTO, indicator, and wherein the physical layer procedure comprises receiving the UTO indicator from a higher layer of a protocol stack within the UE.

13. (canceled)

14. (canceled)

15. The method of claim 1, wherein the physical layer procedure comprises determining a periodicity with which to transmit the indicator, and the periodicity of transmission of the indicator is different than a periodicity of the transmission occasions.

16. (canceled)

17. The method of claim 1, wherein the physical layer procedure comprises determining a radio resource control, RRC, parameter to use when transmitting the indicator, and the RRC parameter comprises a beta offset parameter.

18.-30. (canceled)

31. A user equipment, UE, adapted configured to:
receive a configuration for providing, to a network node in a wireless communication network, an indicator of a subset of a set of transmission occasions that are configured for the UE for performing uplink transmission, the subset of transmission occasions corresponding to transmission occasions, within the set of transmission occasions, that will all be used, may be used, or will be unused, by the UE to perform uplink transmission;
identify the subset of transmission occasions;
determine a physical layer procedure for providing the indicator to the network node based on the identified subset of transmission occasions; and
transmit the indicator that indicates the identified subset of transmission occasions to the network node in accordance with the determined physical layer procedure.

32. (canceled)

33. A method performed by a network node of a wireless communication network, the method comprising:
configuring a user equipment, UE, with a configured grant that configures the UE with a set of transmission occasions for performing uplink transmission;
receiving an indicator from the UE indicating a subset of the set of transmission occasions that are configured for the UE for performing uplink transmission, the subset of transmission occasions to transmission occasions, within the set of transmission occasions, that will all be used, may be used, or will be unused, by the UE to perform uplink transmission; and
scheduling one or both future transmissions and receptions in the set of transmission occasions based on the indicator.

34.-37. (canceled)

38. A network node of a wireless communication network, the network node configured to:
configure a user equipment, UE, with a configured grant that configures the UE with a set of transmission occasions for performing uplink transmission;
receive an indicator from the UE indicating a subset of the set of transmission occasions that are configured for the UE for performing uplink transmission, the subset of transmission occasions corresponding to transmission occasions, within the set of transmission occasions, that will all be used, may be used, or will be unused, by the UE to perform uplink transmission; and
schedule one or both future transmissions and receptions in the set of transmission occasions based on the indicator.

39. (canceled)

40. The method of claim 2, wherein the physical layer procedure comprises generating unused transmission occasion, UTO, uplink control information, UCI, UTO-UCI, including the indicator.

41. The method of claim 2, wherein the indicator that indicates the identified subset of transmission occasions comprises an unused transmission occasion, UTO, indicator, and wherein the physical layer procedure comprises receiving the UTO indicator from a higher layer of a protocol stack within the UE.

42. The method of claim 2, wherein the physical layer procedure comprises determining a periodicity with which to transmit the indicator, and the periodicity of transmission of the indicator is different than a periodicity of the transmission occasions.
